(19) United States
(12) Patent Application Publication
(10) Pub. No.: US 2018/0355113 A1
(43) Pub. Date: Dec. 13, 2018

(54) POLYCARBONATE-BASED RESIN COMPOSITION AND MOLDED ARTICLE THEREOF

(71) Applicant: IDEMITSU KOSAN CO., LTD., Tokyo (JP)

(72) Inventors: Masami TAKIMOTO, Sodegaura-shi, Chiba (JP); Yasuhiro MOGI, Kisarazu-shi, Chiba (JP)

(73) Assignee: IDEMITSU KOSAN CO., LTD., Tokyo (JP)

(21) Appl. No.: 16/064,065

(22) PCT Filed: Dec. 19, 2016
(86) PCT No.: PCT/JP2016/087822

§ 371 Date: Jun. 20, 2018

(30) Foreign Application Priority Data
Dec. 22, 2015 (JP) 2015-249912

(51) Int. Cl. C08G 77/448; C08K 3/22; C08K 9/02; C08K 5/20; C08K 5/29; C08K 11/00; C08K 5/1515; C08K 5/526; C08K 13/02

(52) U.S. Cl. CPC C08G 77/448; C08K 3/22; C08K 9/02; C08K 5/20; C08K 5/29; C08K 13/08; C08K 5/1515; C08K 5/526; C08K 13/02; C08K 2201/014; C08K 2003/2241; C08K 11/00

(57) ABSTRACT

Provided is a polycarbonate-based resin composition, including a polycarbonate-based resin (A) containing a predetermined polycarbonate-polyorganosiloxane copolymer (A1), and 0.5 part by mass to 40 parts by mass of a white pigment (B) and 0.02 part by mass to 5.0 parts by mass of a hydrolysis resistant agent (C) with respect to 100 parts by mass of the polycarbonate-based resin (A).

### TECHNICAL FIELD

The present invention relates to a polycarbonate-based resin composition and a molded article thereof, and more specifically, to a polycarbonate-based resin composition that contains a polycarbonate-polyorganosiloxane copolymer and a white pigment, that is suppressed in occurrence of a black streak at the time of its molding, and that is excellent in low-temperature impact resistance, and a molded article thereof.

### BACKGROUND ART

A polycarbonate resin is excellent in mechanical strength, electrical characteristics, transparency, and the like, and hence has been widely utilized as an engineering plastic in various fields, such as the field of electrical and electronic equipment, and the field of automobiles. And also, the polycarbonate resin is utilized in a casing for a cellular phone, a mobile personal computer, a digital camera, a video camera, an electric tool, or the like. In these applications, impact resistance is important because of a risk of dropping during handling. In addition, a design property (especially a color) is also an important factor.

A desired color can be imparted to a resin material typified by the polycarbonate resin with relative ease by blending the material with a colorant, such as a pigment. Among polycarbonate-based resins, a polycarbonate-polyorganosiloxane copolymer (hereinafter sometimes referred to as “PC-POS copolymer”) obtained by copolymerizing a polyorganosiloxane is excellent in impact resistance, and hence has been expected to be applied to the foregoing applications.

The PC-POS copolymer has heat resistance and hydrolysis resistance comparable to those of a general (i.e., POS-free) polycarbonate. Accordingly, the application of the copolymer to a thin-walled molded article or a high-strength member to be used under severe conditions or a severe environment has been advanced by exploiting its features, that is, high impact strength and excellent moldability. However, a resin composition obtained by blending a polycarbonate-based resin containing the PC-POS copolymer as a main component with a white pigment, such as titanium oxide, involves a problem in that a black streak-like pattern (black streak) occurs at the time of its molding. Accordingly, a polycarbonate-based resin composition that has a high whiteness, that does not cause color unevenness or the like, and that is excellent in low-temperature impact-resisting characteristic has been desired.

In Patent Document 1, there is a description that when a PC-POS copolymer in which the average chain length of a polyorganosiloxane moiety is short and a PC-POS copolymer in which the average chain length is long are used in combination in a polycarbonate-based resin composition containing a PC-POS copolymer and titanium oxide, a polycarbonate-based resin composition that is suppressed in occurrence of a black streak at the time of its molding and that is excellent in impact resistance is obtained. However, the use of the PC-POS copolymer in which the average chain length of the polyorganosiloxane moiety is short is essential in the resin composition disclosed in Patent Document 1. Accordingly, the impact resistance of the resin composition, in particular, impact resistance at low temperature tends to reduce, and hence it has been desired to further improve the impact resistance.

In addition, in a white pigment, such as titanium oxide, zinc sulfide, or zinc oxide, used in the white-colored polycarbonate-based resin composition of, for example, a white reflective plate to be attached to the backlight unit of an LCD, moisture that cannot be completely removed even when the resin composition is sufficiently dehumidified and dried at from 100° C. to 120° C. serving as a condition for preliminary drying to be performed before typical polycarbonate molding remains. It has been known that when the resin composition containing the moisture is subjected to injection molding, the moisture is transpired by molding heat to cause a silver streak. In order to overcome the problem, there has been known a technology involving suppressing the occurrence of a silver streak through the use of a polycarbonate resin composition containing a combination of a polycarbonate-based polymer and titanium oxide in which a difference between moisture concentrations at 100° C. and 300° C. measured by a Karl-Fischer method of titanium oxide is reduced to 2,700 ppm by mass or less (e.g., Patent Document 2). However, also in Patent Document 2, there is no disclosure of a technology involving suppressing the occurrence of a black streak at the time of molding serving as a phenomenon specific to a polycarbonate-based resin composition containing a PC-POS copolymer and a white pigment.

### CITATION LIST

### Patent Document

Patent Document 1: WO 2013/051557 A1

Patent Document 2: WO 2006/030791 A1

### SUMMARY OF INVENTION

### Technical Problem

An object of the present invention is to provide a polycarbonate-based resin composition that contains a PC-POS copolymer and a white pigment, and that is suppressed in occurrence of a black streak at the time of its molding while maintaining excellent low-temperature impact resistance derived from the PC-POS copolymer, and a molded article thereof.

### Solution to Problem

The inventors of the present invention have found that the object is achieved by providing a polycarbonate-based resin composition obtained by blending predetermined amounts of the following respective components: a polycarbonate-based resin containing a predetermined PC-POS copolymer, a white pigment, and a predetermined amount of a hydrolysis resistant agent.

That is, the present invention relates to the following items 1 to 19.

1. A polycarbonate-based resin composition, comprising a polycarbonate-based resin (A) containing a polycarbonate-polyorganosiloxane copolymer (A1) containing a polycarbonate block formed of a repeating unit represented by the following general formula (I) and a polyorganosiloxane block containing a repeating unit represented by the following general formula (II), and 0.5 part by mass or more to 40 parts by mass or less of a white pigment (B) and 0.02 part by mass or more to 5.0 parts by mass or less of a hydrolysis resistant agent (C) with respect to 100 parts by mass of the polycarbonate-based resin (A):

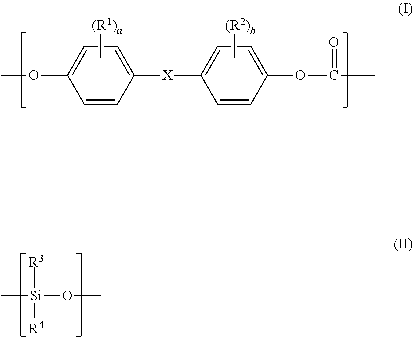

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and a and b each independently represent an integer of from 0 to 4.

2. The resin composition according to Item 1, wherein the polyorganosiloxane block has an average chain length of 50 or more.

3. The resin composition according to Item 1 or 2, wherein a content of the polycarbonate-polyorganosiloxane copolymer (A1) in the polycarbonate-based resin (A) is 10 mass % or more to 100 mass % or less.

4. The resin composition according to any one of Items 1 to 3, wherein a content of the polyorganosiloxane block in the polycarbonate-polyorganosiloxane copolymer (A1) is 1.0 mass % or more to 70 mass % or less.

5. The resin composition according to any one of Items 1 to 4, wherein a moisture concentration value of the white pigment (B) obtained by subtracting a moisture concentration thereof measured at from 0° C. to 120° C. by a Karl-Fischer method from a moisture concentration thereof measured at from 0° C. to 300° C. by the Karl-Fischer method is 8,000 ppm by mass or less.

6. The resin composition according to any one of Items 1 to 5, wherein the white pigment (B) comprises one or more selected from the group consisting of titanium oxide, zinc sulfide, zinc oxide, and barium sulfate.

7. The resin composition according to Item 6, wherein the white pigment (B) comprises titanium oxide. 8. The resin composition according to Item 7, wherein a crystal structure of the titanium oxide comprises a rutile-type structure.

9. The resin composition according to Item 7 or 8, wherein the titanium oxide has, on titanium oxide having an average particle diameter of from 0.10 μm to 0.45 μm, a metal oxide layer formed of an oxide of one or more metals selected from the group consisting of silicon, aluminum, titanium, zinc, and zirconium, and an organic layer containing one or more compounds selected from the group consisting of a polyol, a siloxane, a silane coupling agent, and stearic acid in the stated order.

10. The resin composition according to any one of Items 1 to 9, wherein the hydrolysis resistant agent (C) comprises one or more selected from the group consisting of an amide compound (C1), an imide compound (C2), and an epoxy compound (C3).

11. The resin composition according to Item 10, wherein the amide compound (C1) comprises one or more amide compounds selected from the group consisting of compounds represented by the following general formula (c1-a), the following general formula (c1-b), and the following general formula (c1-c):

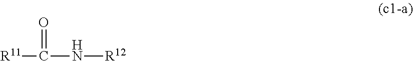

wherein R¹¹ represents a chain aliphatic group having 6 to 24 carbon atoms, and R¹² represents a hydrogen atom or a chain aliphatic group having 6 to 24 carbon atoms;

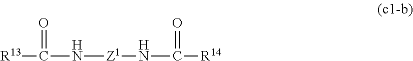

wherein R¹³ and R¹⁴ each independently represent a chain aliphatic group having 6 to 24 carbon atoms, and Z¹ represents a divalent group having 1 to 12 carbon atoms;

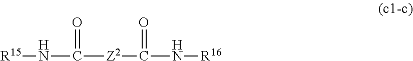

wherein R¹⁵ and R¹⁶ each independently represent a chain aliphatic group having 6 to 24 carbon atoms, and Z² represents a divalent group having 1 to 12 carbon atoms.

12. The resin composition according to Item 10, wherein the imide compound (C2) comprises a carbodiimide compound.

13. The resin composition according to Item 10, wherein the epoxy compound (C3) comprises a cyclic epoxy compound.

14. The resin composition according to Item 10, wherein the epoxy compound (C3) comprises one or more epoxidized oils selected from the group consisting of an epoxidized natural oil and an epoxidized synthetic oil.

15. The resin composition according to any one of Items 10 to 14, wherein a blending amount of the amide compound (C1) with respect to 100 parts by mass of the polycarbonate-based resin (A) is 0.1 part by mass or more to 5.0 parts by mass or less.

16. The resin composition according to any one of Items 10 to 14, wherein a blending amount of the imide compound (C2) with respect to 100 parts by mass of the polycarbonate-based resin (A) is 0.1 part by mass or more to 5.0 parts by mass or less.

17. The resin composition according to any one of Items 10 to 14, wherein a blending amount of the epoxy compound (C3) with respect to 100 parts by mass of the polycarbonate-based resin (A) is 0.02 part by mass or more to 0.5 part by mass or less.

18. The resin composition according to any one of Items 1 to 17, further comprising an antioxidant (D).

19. A molded article, comprising the resin composition of any one of Items 1 to 18.

### Advantageous Effects of Invention

The polycarbonate-based resin composition of the present invention can provide a white molded article having satisfactory low-temperature impact resistance because the resin composition is suppressed in occurrence of a black streak at the time of its molding despite containing the PC-POS copolymer and the white pigment, and can maintain excellent low-temperature impact resistance derived from the PC-POS copolymer. The molded article can be suitably used in parts for electrical and electronic equipment or casings for the equipment, parts for the interior and exterior of lighting equipment, parts for the interior and exterior of a vehicle, food trays, and eating utensils. In particular, the molded article is suitable as a material for a casing for a cellular phone, a mobile personal computer, a digital camera, a video camera, an electric tool, or the like.

### DESCRIPTION OF EMBODIMENTS

A polycarbonate-based resin composition of the present invention is described in detail below. In this description, a specification considered to be preferred can be arbitrarily adopted, and a combination of preferred specifications can be said to be more preferred. In addition, the term “XX to YY” as used herein means “from XX or more to YY or less.”

### [Polycarbonate-Based Resin Composition]

A polycarbonate-based resin composition of the present invention comprises: a polycarbonate-based resin (A) containing a polycarbonate-polyorganosiloxane copolymer (A1) containing a polycarbonate block formed of a repeating unit represented by the following general formula (I) and a polyorganosiloxane block containing a repeating unit represented by the following general formula (II), and 0.5 part by mass or more to 40 parts by mass or less of a white pigment (B) and 0.02 part by mass or more to 5.0 parts by mass or less of a hydrolysis resistant agent (C) with respect to 100 parts by mass of the polycarbonate-based resin (A):

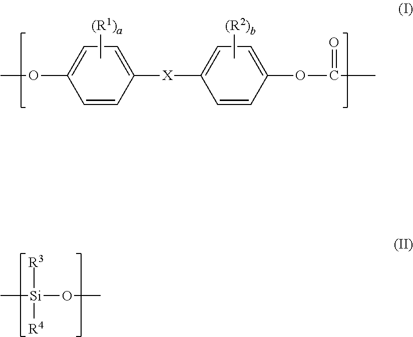

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and a and b each independently represent an integer of from 0 to 4.

### <Polycarbonate-Based Resin (A)>

The polycarbonate-based resin composition of the present invention comprises the polycarbonate-based resin (A) containing the predetermined polycarbonate-polyorganosiloxane copolymer (A1).

### (Polycarbonate-Polyorganosiloxane Copolymer (A1))

The polycarbonate-polyorganosiloxane copolymer (A1) contains a polycarbonate block formed of a repeating unit represented by the following general formula (I) and a polyorganosiloxane block containing a repeating unit represented by the following general formula (II).

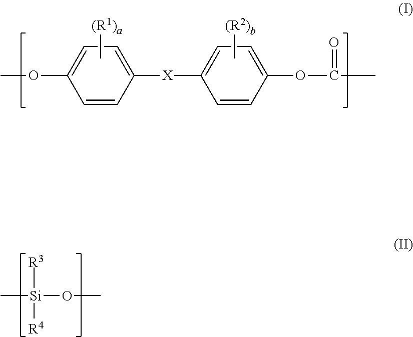

In the general formula (I), R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and a and b each independently represent an integer of from 0 to 4.

In the general formula (II), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.

Examples of the halogen atom that R¹ and R² in the general formula (I) each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups (“various” means that a linear group and any branched group are included, and the same applies hereinafter), various pentyl groups, and various hexyl groups. An example of the alkoxy group that R¹ and R² each independently represent is an alkoxy group whose alkyl group moiety is the alkyl group described above.

The alkylene group represented by X is, for example, a methylene group, an ethylene group, a trimethylene group, a tetramethylene group, or a hexamethylene group, and is preferably an alkylene group having 1 to 5 carbon atoms. Examples of the alkylidene group represented by X include an ethylidene group and an isopropylidene group. The cycloalkylene group represented by X is, for example, a cyclopentanediyl group, a cyclohexanediyl group, or a cyclooctanediyl group, and is preferably a cycloalkylene group having 5 to 10 carbon atoms. The cycloalkylidene group represented by X is, for example, a cyclohexylidene group, a 3,5,5-trimethylcyclohexylidene group, or a 2-adamantylidene group, and is preferably a cycloalkylidene group having 5 to 10 carbon atoms, more preferably a cycloalkylidene group having 5 to 8 carbon atoms. As an aryl moiety of the arylalkylene group represented by X, there are given, for example, aryl groups each having 6 to 14 ring-forming carbons, such as a phenyl group, a naphthyl group, a biphenyl group, and an anthryl group. As an aryl moiety of the arylalkylidene group represented by X, there are given, for example, aryl groups each having 6 to 14 ring-forming carbons, such as a phenyl group, a naphthyl group, a biphenyl group, and an anthryl group.

a and b each independently represent an integer of from 0 to 4, preferably from 0 to 2, more preferably 0 or 1.

Among them, the following is suitable: a repeating unit in which a and b each represent 0, and X represents a single bond or an alkylene group having 1 to 8 carbon atoms, or a repeating unit in which a and b each represent 0, and X represents an alkylene group having 3 carbon atoms, particularly an isopropylidene group.

Examples of the halogen atom that R³ and R⁴ in the general formula (II) each independently represent include a fluorine atom, a chlorine atom, a bromine atom, and an iodine atom. Examples of the alkyl group that R³ and R⁴ each independently represent include a methyl group, an ethyl group, a n-propyl group, an isopropyl group, various butyl groups, various pentyl groups, and various hexyl groups.

An example of the alkoxy group that R³ and R⁴ each independently represent is an alkoxy group whose alkyl group moiety is the alkyl group described above. Examples of the aryl group that R³ and R⁴ each independently represent include a phenyl group and a naphthyl group.

R³ and R⁴ each preferably represent a hydrogen atom, an alkyl group having 1 to 6 carbon atoms, an alkoxy group having 1 to 6 carbon atoms, or an aryl group having 6 to 12 carbon atoms, and each more preferably represent a methyl group.

The polyorganosiloxane block containing a repeating unit represented by the general formula (II) preferably contains a unit represented by any one of the following general formulae (II-I) to (II-III):

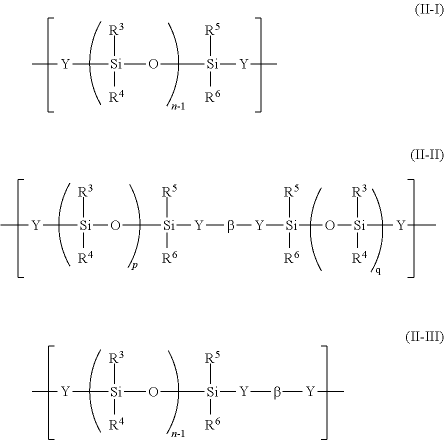

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵ or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷—R¹⁰—O—, and a plurality of Y maybe identical to or different from each other, the R⁷ represents a single bond, a linear, branched, or cyclic alkylene group, a divalent organic residue containing an aliphatic group and an aromatic group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a halide of a dicarboxylic acid, n represents the average chain length of a polyorganosiloxane, p and q each represent an integer of 1 or more, and the sum of p and q is n-2.

Examples of the halogen atom that R³ to R⁶ each independently represent include a fluorine atom, a chlorine atom, a bromine atom, and an iodine atom. Examples of the alkyl group that R³ to R⁶ each independently represent include a methyl group, an ethyl group, a n-propyl group, an isopropyl group, various butyl groups, various pentyl groups, and various hexyl groups. An example of the alkoxy group that R³ to R⁶ each independently represent is an alkoxy group whose alkyl group moiety is the alkyl group described above. Examples of the aryl group that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

It is preferred that R³ to R⁶ in the general formula (II-I), the general formula (II-II), and/or the general formula (II-III) each represent a methyl group.

The linear or branched alkylene group represented by R⁷ in —R⁷O—, —R⁷COO—, —R⁷NH—, —R⁷NR⁸—, —R⁷COO—R⁹—O—, or —R⁷O—R¹⁰—O— represented by Y is, for example, an alkylene group having 1 to 8, preferably 1 to 5 carbon atoms, and the cyclic alkylene group represented by R⁷ is, for example, a cycloalkylene group having 5 to 15, preferably 5 to 10 carbon atoms.

The divalent organic residue containing an aliphatic group and an aromatic group represented by R⁷ may further have a substituent, such as an alkoxy group or an alkyl group, on its aromatic ring, and a specific structure thereof may be, for example, a structure represented by the following general formula (x) or (xi), provided that in the case of the following general formula, the alkylene group is bonded to Si:

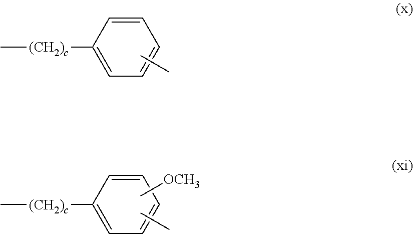

wherein c represents a positive integer and typically represents an integer of from 1 to 6.

The diarylene group represented by any one of R⁷, R⁹, and R¹⁰ is a group in which two arylene groups are linked to each other directly or through a divalent organic group, and is specifically a group having a structure represented by —Ar¹—W—Ar²—. Here, Ar¹ and Ar² each represent an arylene group, and W represents a single bond or a divalent organic group. Examples of the divalent organic group represented by W include an isopropylidene group, a methylene group, a dimethylene group and a trimethylene group.

Examples of the arylene group represented by any one of R⁷, Ar¹ and Ar² include arylene groups each having 6 to 14 ring-forming carbon atoms, such as a phenylene group, a naphthylene group, a biphenylene group, and an anthrylene group. Those arylene groups may each have an arbitrary substituent, such as an alkoxy group or an alkyl group.

The alkyl group represented by R⁸ is a linear or branched group having 1 to 8, preferably 1 to 5 carbon atoms. The alkenyl group represented by R⁸ is, for example, a linear or branched group having 2 to 8, preferably 2 to 5 carbon atoms. The aryl group represented by R⁸ is, for example, a phenyl group or a naphthyl group. The aralkyl group represented by R⁸ is, for example, a phenylmethyl group or a phenylethyl group.

The linear, branched, or cyclic alkylene group represented by R¹⁰ is the same as that represented by R⁷.

Y preferably represents —R⁷O—, and R⁷ represents a divalent organic residue containing an aliphatic group and an aromatic group. In particular, R⁷ preferably represents a divalent residue of a phenol-based compound having an alkyl group, and more preferably represents, for example, a divalent organic residue derived from allylphenol or a divalent organic residue derived from eugenol.

Specifically, R⁷ preferably represents a structure represented by the general formula (x) or (xi).

With regard to p and q in the formula (II-II), it is preferred that p=q, i.e., p=(n−2)/2 and q=(n−2)/2.

β represents a divalent group derived from a diisocyanate compound, or a divalent group derived from a dicarboxylic acid or a halide of a dicarboxylic acid, and examples thereof include divalent groups represented by the following general formulae (xiii) to (xvii).

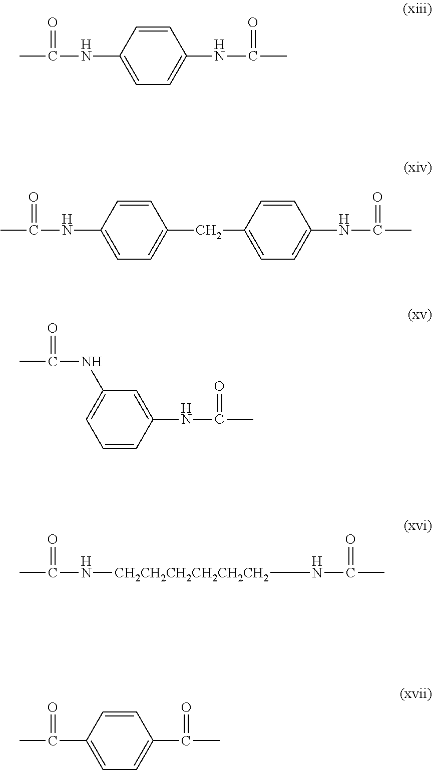

The average chain length n of the polyorganosiloxane block in the PC-POS copolymer (A1) to be used in the present invention is preferably 50 or more. That is, n in each of the formulae (II-I) and (II-III) is preferably 50 or more, and in the case of the formula (II-II), a number obtained by adding 2 to the sum of p and q preferably falls within the range. The average chain length is calculated by nuclear magnetic resonance (NMR) measurement.

When the average chain length n is 50 or more, the low-temperature impact resistance of a molded article of the resin composition is satisfactory. The average chain length n is preferably 60 or more to 500 or less, more preferably 70 or more to 300 or less, still more preferably 80 or more to 150 or less. The average chain length is calculated by nuclear magnetic resonance (NMR) measurement. When the average chain length n is 500 or less, a resin composition suppressed in occurrence of a black streak at the time of its molding and a molded article thereof can be obtained.

The content of the polyorganosiloxane block in the PC-POS copolymer (A1) to be used in the present invention is preferably 1.0 mass % or more to 70 mass % or less, more preferably 1.0 mass % or more to 25 mass % or less, still more preferably 2.0 mass % or more to 10 mass % or less, still further more preferably 4.0 mass % or more to 8.0 mass % or less.

The viscosity-average molecular weight (Mv) of the PC-POS copolymer (A1) to be used in the present invention, which can be appropriately adjusted with, for example, a molecular weight modifier so as to be a molecular weight intended for an application or a product in which the copolymer is used, is preferably from 12,000 to 30,000, more preferably from 15,000 to 25,000, still more preferably from 16,000 to 22,000, still further more preferably from 16,000 to 20,000. When the viscosity-average molecular weight is 12,000 or more, a molded article having a sufficient impact strength can be obtained. When the viscosity-average molecular weight is 30,000 or less, the fluidity of the copolymer is not excessively low and hence its moldability is satisfactory. Accordingly, the injection molding or extrusion molding of the composition can be performed at such a temperature that its heat deterioration does not occur.

The viscosity-average molecular weight (Mv) is a value calculated from the following Schnell's equation by measuring the limiting viscosity [η] of a methylene chloride solution at 20° C. (concentration: g/L).

[η]=1.23×10⁻⁵×Mv^{0.83}

The PC-POS copolymers (A1) may be used alone or in combination thereof. A case in which two or more of the PC-POS copolymers (A1) are used is, for example, a case in which two or more of PC-POS copolymers different from each other in average chain length of the polyorganosiloxane block, content of the polyorganosiloxane block, or viscosity-average molecular weight are combined.

### (Other Polycarbonate-Based Resin (A2))

The polycarbonate-based resin (A) to be used in the present invention may further contain a polycarbonate-based resin (A2) except the PC-POS copolymers (A1). The polycarbonate-based resin (A2) is preferably an aromatic polycarbonate-based resin, more preferably an aromatic polycarbonate-based resin formed only of a repeating unit represented by the following general formula (III):

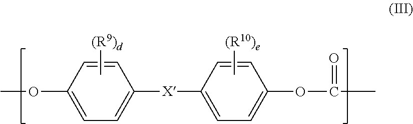

wherein R⁹ and R¹⁰ each independently represent a halogen atom, an alkyl group having 1 to 6 carbon atoms, or an alkoxy group having 1 to 6 carbon atoms, X′ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and d and e each independently represent an integer of from 0 to 4.

Specific examples of R⁹ and R¹⁰ include the same examples as those of the R¹ and the R², and preferred examples thereof are also the same as those of the R¹ and the R². R⁹ and R¹⁰ each more preferably represent an alkyl group having 1 to 6 carbon atoms or an alkoxy group having 1 to 6 carbon atoms. Specific examples of X′ include the same examples as those of the X, and preferred examples thereof are also the same as those of the X. d and e each independently represent preferably from 0 to 2, more preferably 0 or 1.

The content of the PC-POS copolymer (A1) in the polycarbonate-based resin (A) is preferably 10 mass % or more to 100 mass % or less, more preferably 50 mass % or more to 100 mass % or less, still more preferably 80 mass % or more to 100 mass % or less from the viewpoint that impact resistance is obtained.

The amount of the polyorganosiloxane in the polycarbonate-based resin (A) is preferably 1.0 mass % or more to 25 mass % or less, more preferably 2.0 mass % or more to 20 mass % or less, still more preferably 3.0 mass % or more to 10 mass % or less from the viewpoint that impact resistance is obtained.

The viscosity-average molecular weight (Mv) of the polycarbonate-based resin (A), which can be appropriately adjusted so as to be a molecular weight intended for an application or a product in which the resin is used, is preferably from 12,000 to 30,000, more preferably from 15,000 to 25,000, still more preferably from 16,000 to 22,000, still further more preferably from 16,000 to 20,000. When the viscosity-average molecular weight is 12,000 or more, a sufficient strength of a molded article of the resin composition can be obtained. When the viscosity-average molecular weight is 30,000 or less, the fluidity of the resin composition is not excessively low and hence its moldability is satisfactory. Accordingly, the injection molding or extrusion molding of the resin composition can be performed at such a temperature that its heat deterioration does not occur.

The viscosity-average molecular weight (Mv) can be determined by the same method as that described above.

### (Method of Producing PC-POS Copolymer (A1))

The PC-POS copolymer (A1) in the polycarbonate-based resin composition of the present invention can be produced by a known production method, such as an interfacial polymerization method (phosgene method), a pyridine method, or an ester exchange method. Particularly in the case of the interfacial polymerization method, the step of separating an organic phase containing the PC-POS copolymer and an aqueous phase containing an unreacted substance, a catalyst residue, or the like becomes easy, and the separation of the organic phase containing the PC-POS copolymer and the aqueous phase in each washing step based on alkali washing, acid washing, or pure water washing becomes easy. Accordingly, the PC-POS copolymer is efficiently obtained. With regard to the method of producing the PC-POS copolymer, reference can be made to a method described in, for example, JP 2005-60599 A.

Specifically, the copolymer can be produced by: dissolving an aromatic polycarbonate oligomer produced in advance to be described later and the polyorganosiloxane in a water-insoluble organic solvent (such as methylene chloride); adding an alkaline compound aqueous solution (such as aqueous sodium hydroxide) of a dihydric phenol-based compound (such as bisphenol A) to the solution; and subjecting the mixture to an interfacial polycondensation reaction through the use of a tertiary amine (such as triethylamine) or a quaternary ammonium salt (such as trimethylbenzylammonium chloride) as a polymerization catalyst in the presence of a terminal stopper (a monohydric phenol, such as p-t-butylphenol). In addition, the PC-POS copolymer (A1) can be produced by copolymerizing the polyorganosiloxane, a dihydric phenol, and phosgene, a carbonate ester, or a chloroformate.

When the PC-POS copolymer (A1) is produced by, for example, causing the polycarbonate oligomer and a polyorganosiloxane raw material to react with each other in an organic solvent, and then causing the resultant to react with the dihydric phenol, the solid weight (g/L) of the polycarbonate oligomer in 1 L of a mixed solution of the organic solvent and the polycarbonate oligomer falls within the range of preferably 80 to 200 g/L, more preferably 90 to 180 g/L, still more preferably 100 to 170 g/L.

A polyorganosiloxane represented by the following general formula (i), the following general formula (ii), and/or the following general formula (iii) can be used as the polyorganosiloxane serving as a raw material for the PC-POS copolymer (A1):

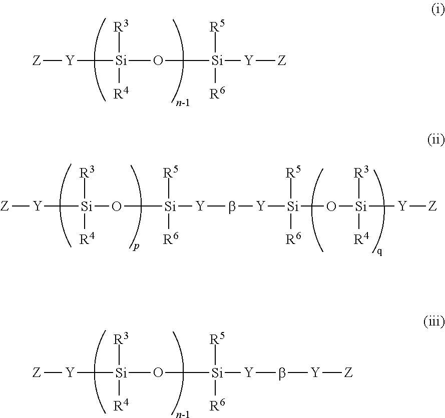

wherein R³ to R⁶, Y, β, n-1, p, and q are as described above, and specific examples thereof and preferred examples thereof are also the same as those described above.

Z represents a hydrogen atom or a halogen atom, and a plurality of Z may be identical to or different from each other.

Examples of the polyorganosiloxane represented by the general formula (i) include compounds represented by the following general formulae (i-i) to (i-xi):

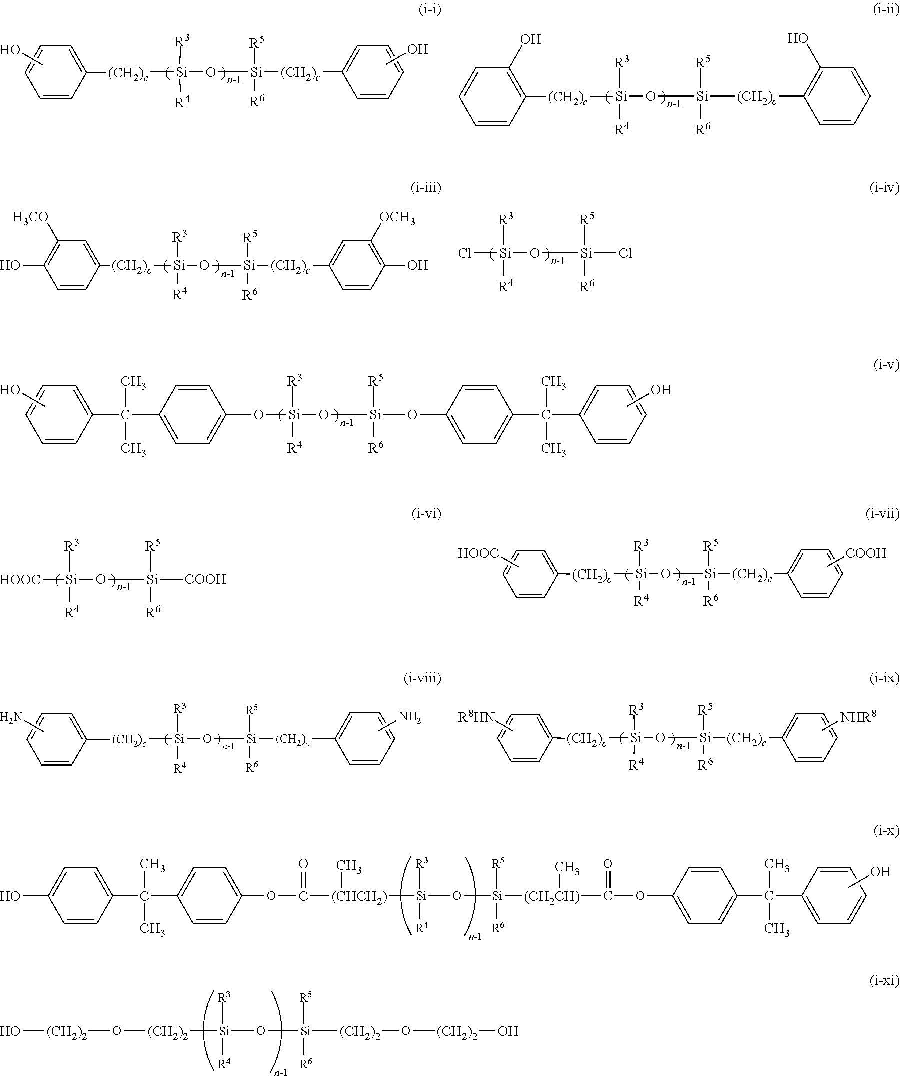

In the formulae (i-i) to (i-xi), R³ to R⁶, n, and R⁸ are as defined above, and preferred examples thereof are also the same as those described above, and c represents a positive integer and typically represents an integer of from 1 to 6.

Among them, a phenol-modified polyorganosiloxane represented by the general formula (i-i) is preferred from the viewpoint of its ease of polymerization. An α,ω-bis[3-(o-hydroxyphenyl)propyl]polydimethylsiloxane, which is one compound represented by the general formula (i-ii), or an α,ω-bis[3-(4-hydroxy-3-methoxyphenyl)propyl]polydimethylsiloxane, which is one compound represented by the general formula (i-iii), is preferred from the viewpoint of its ease of availability.

In addition to the foregoing, a compound having a structure represented by the following general formula (xii) may be used as a polyorganosiloxane raw material:

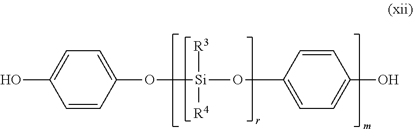

wherein R³ and R⁴ are identical to those described above. The average chain length of the polyorganosiloxane block represented by the general formula (xii) is (r×m), and the range of the (r×m) is the same as that of the n.

When the compound represented by the general formula (xii) is used as a polyorganosiloxane raw material, the polyorganosiloxane block (II) preferably has a unit represented by the following general formula (II-IV):

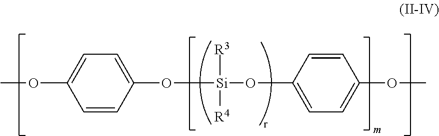

wherein R³, R⁴, r, and m are as described above.

A method of producing the polyorganosiloxane is not particularly limited. According to, for example, a method described in JP 11-217390 A, a crude polyorganosiloxane can be obtained by: causing cyclotrisiloxane and disiloxane to react with each other in the presence of an acid catalyst to synthesize α,ω-dihydrogen organopentasiloxane; and then subjecting a phenolic compound (such as 2-allylphenol, 4-allylphenol, eugenol, or 2-propenylphenol) or the like to an addition reaction with the α,ω-dihydrogen organopentasiloxane in the presence of a catalyst for a hydrosilylation reaction. According to a method described in JP 2662310 B2, the crude polyorganosiloxane can be obtained by: causing octamethylcyclotetrasiloxane and tetramethyldisiloxane to react with each other in the presence of sulfuric acid (acid catalyst); and subjecting a phenolic compound or the like to an addition reaction with the resultant α,ω-dihydrogen organopolysiloxane in the presence of the catalyst for a hydrosilylation reaction in the same manner as described above. The average chain length n of the α,ω-dihydrogen organopolysiloxane can be appropriately adjusted depending on a polymerization condition therefor before its use, or a commercially available α,ω-dihydrogen organopolysiloxane may be used.

Examples of the catalyst for a hydrosilylation reaction include transition metal-based catalysts. Among them, a platinum-based catalyst is preferably used in terms of a reaction rate and selectivity. Specific examples of the platinum-based catalyst include chloroplatinic acid, a solution of chloroplatinic acid in an alcohol, an olefin complex of platinum, a complex of platinum and a vinyl group-containing siloxane, platinum-supported silica, and platinum-supported activated carbon.

An adsorbent is preferably caused to adsorb and remove a transition metal derived from a transition metal-based catalyst used as the catalyst for a hydrosilylation reaction in the crude polyorganosiloxane by bringing the crude polyorganosiloxane into contact with the adsorbent.

An adsorbent having an average pore diameter of, for example, 1,000 Å or less can be used as the adsorbent. When the average pore diameter is 1,000 Å or less, the transition metal in the crude polyorganosiloxane can be efficiently removed. From such viewpoint, the average pore diameter of the adsorbent is preferably 500 Å or less, more preferably 200 Å or less, still more preferably 150 Å or less, yet still more preferably 100 Å or less. From the same viewpoint, the adsorbent is preferably a porous adsorbent.

The adsorbent is not particularly limited as long as the adsorbent has the above-mentioned average pore diameter. For example, there may be used activated clay, acidic clay, activated carbon, synthetic zeolite, natural zeolite, activated alumina, silica, a silica-magnesia-based adsorbent, diatomaceous earth, and cellulose. Among them, preferred is at least one selected from the group consisting of activated clay, acidic clay, activated carbon, synthetic zeolite, natural zeolite, activated alumina, silica, and a silica-magnesia-based adsorbent.

After the adsorbent has been caused to adsorb the transition metal in the crude polyorganosiloxane, the adsorbent can be separated from the polyorganosiloxane by arbitrary separating means. Examples of the means for separating the adsorbent from the polyorganosiloxane include a filter and centrifugation. When the filter is used, a filter such as a membrane filter, a sintered metal filter, or a glass fiber filter can be used. Among them, the membrane filter is particularly preferably used.

The average particle diameter of the adsorbent is typically from 1 μm to 4 mm, preferably from 1 μm to 100 μm from the viewpoint of separating the adsorbent from the polyorganosiloxane after the adsorption of the transition metal.

When the adsorbent is used, its usage amount is not particularly limited. A porous adsorbent can be used in an amount in the range of preferably from 1 part by mass to 30 parts by mass, more preferably from 2 parts by mass to 20 parts by mass with respect to 100 parts by mass of the crude polyorganosiloxane.

When the crude polyorganosiloxane to be treated has so high a molecular weight that the crude polyorganosiloxane is not in a liquid state, the polyorganosiloxane may be heated to such a temperature as to be in a liquid state upon performance of the adsorption with the adsorbent and the separation of the adsorbent. Alternatively, the adsorption and the separation may be performed under a state in which the polyorganosiloxane is dissolved in a solvent, such as methylene chloride or hexane.

The polycarbonate oligomer can be produced through a reaction of a dihydric phenol and a carbonate precursor, such as phosgene or triphosgene, in an organic solvent, such as methylene chloride, chlorobenzene, or chloroform. When the polycarbonate oligomer is produced by using an ester exchange method, the oligomer can also be produced through a reaction of a dihydric phenol and a carbonate precursor, such as diphenyl carbonate.

A dihydric phenol represented by the following general formula (iv) is preferably used as the dihydric phenol:

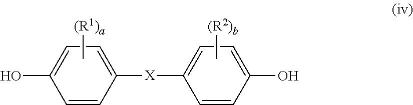

wherein R¹, R², a, b, and X are as described above.

Examples of the dihydric phenol represented by the general formula (iv) include a bis(hydroxyaryl)alkane, a bis(hydroxyaryl)cycloalkane, a dihydroxyaryl ether, a dihydroxydiaryl sulfide, a dihydroxydiaryl sulfoxide, a dihydroxydiaryl sulfone, a dihydroxydiphenyl, a dihydroxydiarylfluorene, and a dihydroxydiaryladamantane. Those dihydric phenols may be used alone or as a mixture thereof.

Examples of the bis(hydroxyaryl)alkane include bis(4-hydroxyphenyl)methane, 1,1-bis(4-hydroxyphenyl)ethane, 2,2-bis(4-hydroxyphenyl)propane [bisphenol A], 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-3-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane.

Examples of the bis(hydroxyaryl)cycloalkane include 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane. Examples of the dihydroxyaryl ether include 4,4′-dihydroxydiphenyl ether and 4,4′-dihydroxy-3,3′-dimethylphenyl ether.

Examples of the dihydroxydiaryl sulfide include 4,4′-dihydroxydiphenyl sulfide and 4,4′-dihydroxy-3,3′-dimethyldiphenyl sulfide. Examples of the dihydroxydiaryl sulfoxide include 4,4′-dihydroxydiphenyl sulfoxide and 4,4′-dihydroxy-3,3′-dimethyldiphenyl sulfoxide. Examples of the dihydroxydiaryl sulfone include 4,4′-dihydroxydiphenyl sulfone and 4,4′-dihydroxy-3,3′-dimethyldiphenyl sulfone.

An example of the dihydroxydiphenyl is4,4′-dihydroxydiphenyl. Examples of the dihydroxydiarylfluorene include 9,9-bis(4-hydroxyphenyl)fluorene and 9,9-bis(4-hydroxy-3-methylphenyl)fluorene. Examples of the dihydroxydiaryladamantane include 1,3-bis(4-hydroxyphenyl)adamantane, 2,2-bis(4-hydroxyphenyl)adamantane, and 1,3-bis(4-hydroxyphenyl)-5,7-dimethyladamantane.

Examples of the dihydricphenol other than the above-mentioned dihydric phenols include 4,4′-[1,3-phenylenebis(1-methylethylidene)]bisphenol, 10,10-bis(4-hydroxyphenyl)-9-anthrone, and 1,5-bis(4-hydroxyphenylthio)-2,3-dioxapentane.

Among them, as the dihydric phenol, a bis(hydroxyaryl)alkane is preferred, a bis(hydroxyphenyl)alkane is more preferred, and bisphenol A is still more preferred. When bisphenol A is used as the dihydric phenol, a polycarbonate-polyorganosiloxane copolymer in which X represents an isopropylidene group and a relationship of a=b=0 is satisfied in the general formula (1) can be provided.

In order to control the molecular weight of the PC-POS copolymer to be obtained, a terminal stopper can be used. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

After the interfacial polycondensation reaction, the liquid is appropriately left at rest to be separated into an aqueous phase and an organic solvent phase, the organic solvent phase is washed (preferably washed with a basic aqueous solution, an acidic aqueous solution, and water in the stated order), and the resultant organic phase is concentrated and dried. Thus, the PC-POS copolymer can be obtained.

### (Production Method for Aromatic Polycarbonate-Based Resin)

The aromatic polycarbonate-based resin can be obtained by a conventional production method for a polycarbonate. Examples of the conventional method include: an interfacial polymerization method involving causing the dihydric phenol-based compound and phosgene to react with each other in the presence of an organic solvent inert to the reaction and an aqueous alkaline solution, adding a polymerization catalyst, such as a tertiary amine or a quaternary ammonium salt, to the resultant, and polymerizing the mixture; and a pyridine method involving dissolving the dihydric phenol-based compound in pyridine or a mixed solution of pyridine and an inert solvent, and introducing phosgene to the solution to directly produce the resin. A molecular weight modifier (terminal stopper), a branching agent, or the like is used as required in the reaction.

The dihydricphenol-based compound is,for example, a compound represented by the following general formula (v):

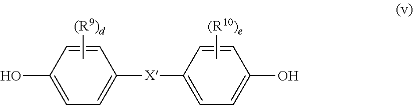

wherein R⁹, R¹⁰, X′, d, and e are as defined above, and preferred examples thereof are also the same as those described above.

Specific examples of the dihydric phenol-based compound may include those described above in the method of producing the PC-POS copolymer (A1), and preferred examples thereof are also the same as those described above. Among them, a bis(hydroxyphenyl)alkane-based dihydric phenol is preferred, and bisphenol A is more preferred.

### <White Pigment (B)>

The polycarbonate-based resin composition of the present invention comprises the white pigment (B). The white pigment (B) is used for making the color tone of the polycarbonate-based resin composition of the present invention white. Although the white pigment (B) is not particularly limited, one or more selected from the group consisting of titanium oxide, zinc sulfide, zinc oxide, and barium sulfate are preferably used. Among those white pigments, the titanium oxide is preferably used from the viewpoint of making the color tone whiter.

The titanium oxide may be produced by any one of a chlorine method and a sulfuric acid method. In addition, any one of a rutile-type structure and an anatase-type structure can be used as the crystal structure of the titanium oxide, but the rutile-type structure is preferred from the viewpoints of, for example, the thermal stability and light resistance of the polycarbonate-based resin composition.

The shapes of the particles of the white pigment (B) are not particularly limited, and examples thereof include a flaky shape, a spherical shape, a plate shape, and an amorphous shape. The average particle diameter of the white pigment (B) is preferably from 0.05 μm to 0.50 μm, more preferably from 0.10 μm to 0.45 μm, still more preferably from 0.15 μm to 0.25 μm from the viewpoint that an excellent color tone is obtained. The average particle diameter of the white pigment (B) is determined from the average of the particle diameters of primary particles based on single particles.

With regard to the amount of moisture in the white pigment (B), a moisture concentration value obtained by subtracting a moisture concentration measured at from 0° C. to 120° C. by a Karl-Fischer method from a moisture concentration measured at from 0° C. to 300° C. by the Karl-Fischer method is preferably 8,000 ppm by mass or less. The moisture concentration value is more preferably 6,000 ppm by mass or less, still more preferably 4,000 ppm by mass or less, still further more preferably 3,000 ppm by mass or less.

When titanium oxide having a metal oxide layer to be described later is used as the white pigment (B), the metal oxide is wettable and hence easily adsorbs moisture. In addition, the metal oxide has such a property as to be chemically bonded to the moisture. Physically adsorbed moisture in the white pigment (B) can be removed at about a general drying temperature of a polycarbonate (from 100° C. to 120° C.). However, the chemically bonded moisture cannot be removed at the temperature, and hence is not transpired unless a higher temperature is adopted. When a polycarbonate-based resin composition comprising the white pigment (B) containing a large amount of the chemically bonded moisture (hereinafter sometimes referred to as “chemically bonded water”) is subjected to injection molding, the number of silver streaks appearing on the surface of a molded article to be obtained tends to be large.

A product having, on titanium oxide serving as a core, a metal oxide layer and an organic layer in the stated order is more preferably used as the titanium oxide to be used as the white pigment (B). The average particle diameter of the titanium oxide serving as the core is preferably from 0.10 μm to 0.45 μm, more preferably from 0.15 μm to 0.25 μm.

The metal oxide layer is preferably formed of an oxide of one or more metals selected from the group consisting of silicon, aluminum, titanium, zinc, and zirconium. The formation of the layer formed of any such metal oxide is intended to prevent the catalytic action of the titanium oxide and to improve the affinity of the pigment for the polycarbonate-based resin.

As the coverage of the metal oxide layer to be formed on the titanium oxide increases, the amount of the chemically bonded water increases, and hence the thickness of the metal oxide layer is preferably as small as possible to the extent that its function is not impaired.

A method of forming the metal oxide layer is not particularly limited, and an arbitrary method is used. The number of kinds of metal oxides to be used in the metal oxide layer may be one, or may be two or more.

The organic layer preferably contains one or more compounds selected from the group consisting of a polyol, a siloxane, a silane coupling agent, and stearic acid. The formation of the organic layer is intended to alleviate the agglomerating properties of white pigment particles and to improve the dispersibility thereof in the resin composition of the present invention.

The polyol only needs to be a compound containing two or more hydroxy groups in a molecule thereof, and examples thereof include trimethylolpropane, trimethylolethane, ditrimethylolpropane, trimethylolpropane ethoxylate, and pentaerythritol. Those polyols may be used alone or in combination thereof. Among them, one or more selected from the group consisting of trimethylolpropane and trimethylolethane are preferred from the viewpoint that a reduction in impact resistance of the resin composition can be prevented.

A compound for forming the organic layer containing the siloxane is, specifically, for example, an alkyl hydrogen silicone or an alkoxy silicone. Examples of the alkyl hydrogen silicone include methyl hydrogen silicone and ethyl hydrogen silicone. Examples of the alkoxy silicone include methoxy silicone and ethoxy silicone. A preferred alkoxy silicone is specifically a silicone compound containing an alkoxysilyl group in which an alkoxy group is bonded to a silicon atom directly or through a divalent hydrocarbon group, and examples thereof include linear, cyclic, and network organopolysiloxanes, and a linear organopolysiloxane having a partial branch. Among them, a linear organopolysiloxane is particularly preferred. More specifically, a polyorganosiloxane having a molecular structure in which an alkoxy group is bonded to a silicone main chain through a methylene chain is preferred.

The silane coupling agent is, for example, a silane coupling agent having a (meth) acryloyloxy group, an epoxy group, or an amino group as a reactive group, that is, a (meth) acryloyloxy-based silane coupling agent, an epoxy-based silane coupling agent, or an amino-based silane coupling agent.

The number of kinds of the compounds to be used in the organic layer may be one, or may be two or more. The thickness of the organic layer is arbitrary.

The blending amount of the white pigment (B) in the polycarbonate-based resin composition of the present invention is 0.5 part by mass or more to 40 parts by mass or less, preferably 1.5 parts by mass or more to 20 parts by mass or less, more preferably 1.0 part by mass or more to 5.0 parts by mass or less, still more preferably 1.0 part by mass to more to 3.0 parts by mass or less with respect to 100 parts by mass of the polycarbonate-based resin (A). When the blending amount of the white pigment (B) is less than 0.5 part by mass, the whiteness of the resin composition is insufficient, and when the blending amount is more than 40 parts by mass, the impact resistance thereof reduces.

### <Hydrolysis Resistant Agent (C)>

The polycarbonate-based resin composition of the present invention needs to comprise the hydrolysis resistant agent (C) for preventing the occurrence of a black streak or the like at the time of its molding. When the polycarbonate-based resin composition containing the PC-POS copolymer (Al) and the white pigment (B) comprises a predetermined amount of the hydrolysis resistant agent (C), the occurrence of a black streak at the time of its molding can be suppressed.

The hydrolysis resistant agent in the present invention is an agent having a function of suppressing the hydrolysis of a carbonate group or a siloxane bond in the PC-POS copolymer (A1). In more detail, the agent is an agent having one or more functional groups that can react with moisture or a produced acid.

Specific examples of the hydrolysis resistant agent (C) to be used in the present invention include an amide compound (C1), an imide compound (C2), an epoxy compound (C3), an acid anhydride (C4), an oxazoline compound (C5), an oxazine compound (C6), and a ketene compound (C7).

### (Amide Compound (C1))

The amide compound (C1) to be used in the present invention only needs to be a compound having at least one amide group in a molecule thereof.

The amide compound (C1) is preferably an amide compound having at least one chain aliphatic group having 6 to 24 carbon atoms in a molecule thereof in terms of its effect as a hydrolysis resistant agent and its dispersibility. The chain aliphatic group may be linear or branched, and may be a saturated aliphatic group or an unsaturated aliphatic group. Among them, a saturated chain aliphatic group is preferred from the viewpoint of suppressing the occurrence of a black streak at the time of the molding of the resin composition, and in terms of the fact that the group has an action of being dispersed in the polycarbonate-based resin, and an alkyl group is more preferred. The number of carbon atoms of the chain aliphatic group is preferably from 8 to 22, more preferably from 10 to 22, still more preferably from 12 to 22. The chain aliphatic group may have a substituent, such as a hydroxy group.

Among the amide compounds (C1), an amide compound having one amide group in a molecule thereof (hereinafter sometimes referred to as “monoamide”) is preferably a compound represented by the following general formula (c1-a):

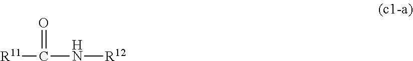

wherein R¹¹ represents a chain aliphatic group having 6 to 24 carbon atoms, and R¹² represents a hydrogen atom or a chain aliphatic group having 6 to 24 carbon atoms. A preferred mode of any such chain aliphatic group is the same as that described above, and the group may have a substituent, such as a hydroxy group.

Examples of the compound represented by the general formula (c1-a) include a fatty acid monoamide and a monoamide obtained by substituting amide hydrogen of the fatty acid monoamide with a chain aliphatic group having 6 to 24 carbon atoms (chain aliphatic group-substituted fatty acid monoamide). Among those described above, a fatty acid monoamide is preferred.

Specific examples of the fatty acid monoamide include caprylamide, capramide, lauramide, myristamide, palmitamide, stearamide, hydroxystearamide, 12-hydroxystearamide, behenamide, montanamide, undecylenamide, oleamide, erucamide, and linoleamide.

Specific examples of the chain aliphatic group-substituted fatty acid monoamide include N-lauryl lauramide, N-palmityl palmitamide, N-stearyl stearamide, N-behenyl behenamide, N-oleyl oleamide, N-stearyl oleamide, N-oleyl stearamide, N-stearyl erucamide, N-oleyl palmitamide, methylol stearamide, methylol behenamide, N-stearyl-12-hydroxystearamide, and N-oleyl-12-hydroxystearamide.

Among the amide compounds (C1), a compound having two amide groups in a molecule thereof is preferably a compound represented by any one of the following general formulae (c1-b) and (c1c), more preferably a compound represented by the general formula (c1b):

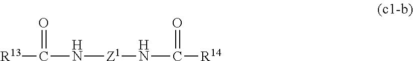

wherein R¹³ and R¹⁴ each independently represent a chain aliphatic group that has 6 to 24 carbon atoms and that may have a hydroxy group, and Z¹ represents a divalent group having 1 to 12 carbon atoms.

A preferred mode of the chain aliphatic group is the same as that described above, and the group may have a substituent, such as a hydroxy group. R¹³ and R¹⁴, which may be identical to or different from each other, are preferably identical to each other.

The number of carbon atoms of Z¹ is preferably from 1 to 8, more preferably from 2 to 6, still more preferably from 2 to 4. Z¹, which may represent any one of a chain aliphatic group, analicyclic structure-containing group, and an aromatic ring-containing group, represents preferably a chain aliphatic group, more preferably an alkylene group.

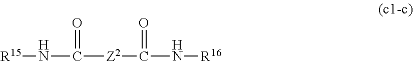

wherein R¹⁵ and R¹⁶ each independently represent a chain aliphatic group having 6 to 24 carbon atoms, and Z² represents a divalent group having 1 to 12 carbon atoms.

A preferred mode of the chain aliphatic group is the same as that described above, and the group may have a substituent, such as a hydroxy group. R¹⁵ and R¹⁶, which may be identical to or different from each other, are preferably identical to each other.

A preferred mode of Z² is the same as that of the Z¹.

A specific example of the compound represented by the general formula (c1-b) is a fatty acid bisamide. Examples thereof include methylenebiscaprylamide, methylenebiscapramide, methylenebislauramide, methylenebismyristamide, methylenebispalmitamide, methylenebisstearamide, methylenebisisostearamide, methylenebisbehenamide, methylenebisoleamide, methylenebiserucamide, ethylenebiscaprylamide, ethylenebiscapramide, ethylenebislauramide, ethylenebismyristamide, ethylenebispalmitamide, ethylenebisstearamide, ethylenebisisostearamide, ethylenebisbehenamide, ethylenebisoleamide, ethylenebiserucamide, butylenebisstearamide, butylenebisbehenamide, butylenebisoleamide, butylenebiserucamide, hexamethylenebisstearamide, hexamethylenebisbehenamide, hexamethylenebisoleamide, hexamethylenebiserucamide, m-xylylenebisstearamide, m-xylylenebis-12-hydroxystearamide, p-xylylenebisstearamide, p-phenylenebisstearamide, methylenebishydroxystearamide, ethylenebishydroxystearamide, butylenebishydroxystearamide, and hexamethylenebishydroxystearamide.

Specific examples of the compound represented by the general formula (c1-c) include N,N′-distearyl adipamide, N,N′-distearyl sebacamide, N,N′-dioleyl adipamide, N,N′-dioleyl sebacamide, N,N′-distearyl isophthalamide, and N,N′-distearyl terephthalamide.

Among the amide compounds (C1), a compound having three or more amide groups in a molecule thereof is preferably, for example, a polycondensate of a dicarboxylic acid, a diamine, and a monocarboxylic acid or a monoamine having a chain aliphatic group having 6 to 24 carbon atoms. A preferred mode of the chain aliphatic group having 6 to 24 carbon atoms is the same as that described above, and the group may have a substituent, such as a hydroxy group.

The dicarboxylic acid, which may be any one of an aliphatic dicarboxylic acid and an aromatic dicarboxylic acid, is preferably an aliphatic dicarboxylic acid, more preferably a chain aliphatic dicarboxylic acid, still more preferably a saturated chain aliphatic dicarboxylic acid in terms of its dispersibility in the polycarbonate-based resin. The number of carbon atoms of the dicarboxylic acid is preferably from. 4 to 20, more preferably from 6 to 18, still more preferably from 6 to 12.

Specific examples of the dicarboxylic acid include oxalic acid, malonic acid, maleic acid, fumaric acid, citraconic acid, itaconic acid, glutaconic acid, succinic acid, adipic acid, sebacic acid, 1,12-dodecanedioic acid, azelaic acid, cyclohexanedicarboxylic acid, phthalic acid, isophthalic acid, and terephthalic acid. Among them, at least one selected from the group consisting of adipic acid, sebacic acid, 1,12-dodecanedioic acid, and azelaic acid is preferred.

The diamine, which may be any one of an aliphatic diamine and an aromatic diamine, is preferably an aliphatic diamine, more preferably a chain aliphatic diamine, still more preferably a saturated chain aliphatic diamine in terms of its dispersibility in the polycarbonate-based resin. The number of carbon atoms of the diamine is preferably from 2 to 18, more preferably from 2 to 12, still more preferably from 2 to 6.

Specific examples of the diamine include ethylenediamine, 1-methylethylenediamine, 1,3-propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, cyclohexanediamine, 1,3-bis(aminomethyl)cyclohexane, 1,4-bis(aminomethyl)cyclohexane, m-xylylenediamine, p-xylylenediamine, and p-bis(2-aminoethyl)benzene. Among them, at least one selected from the group consisting of ethylenediamine, 1-methylethylenediamine, 1,3-propylenediamine, tetramethylenediamine, and hexamethylenediamine is preferred, and ethylenediamine is more preferred.

Examples of the monocarboxylic acid having a chain aliphatic group having 6 to 24 carbon atoms include caprylic acid, capric acid, lauric acid, myristic acid, palmitic acid, stearic acid, hydroxystearic acid, behenic acid, montanic acid, undecylenic acid, oleic acid, erucic acid, and linoleic acid. Among them, at least one selected from the group consisting of lauric acid, myristic acid, palmitic acid, stearic acid, and hydroxystearic acid is preferred, and stearic acid is more preferred.

Examples of the monoamine having a chain aliphatic group having 6 to 24 carbon atoms include hexylamine, heptylamine, octylamine, 2-ethylhexylamine, nonylamine, decylamine, undecylamine, dodecylamine, tridecylamine, tetradecylamine, pentadecylamine, hexadecylamine, heptadecylamine, stearylamine, isostearylamine, nonadecylamine, icosylamine, henicosylamine, docosylamine, tricosylamine, tetracosylamine, 11-ethyltricosylamine, pentacosylamine, hexacosylamine, heptacosylamine, octacosylamine, nonacosylamine, triacontylamine, hexenylamine, heptenylamine, octenylamine, nonenylamine, decenylamine, undecenylamine, dodecenylamine, tridecenylamine, tetradecenylamine, pentadecenylamine, hexadecenylamine, heptadecenylamine, octadecenylamine, nonadecenylamine, icosenylamine, henicosenylamine, docosenylamine, tricosenylamine, tetracosenylamine, pentacosenylamine, hexacosenylamine, heptacosenylamine, octacosenylamine, nonacosenylamine, and triacontenylamine. Among them, one or more selected from the group consisting of octylamine, 2-ethylhexylamine, nonylamine, decylamine, undecylamine, dodecylamine, tridecylamine, tetradecylamine, pentadecylamine, hexadecylamine, heptadecylamine, stearylamine, and isostearylamine are preferred.

Among the amide compounds (C1), in terms of the effects of the present invention, one or more amide compounds selected from the group consisting of the compounds represented by the general formula (c1-a), the general formula (c1-b), and the general formula (c1-c) are more preferred, the compound represented by the general formula (c1-b) is still more preferred, and ethylenebisstearamide is still further more preferred. In addition, among the amide compounds (C1), a compound having a melting point of 100° C. or more, more preferably 150° C. or more is preferred because of its high suitability for the molding temperature of the polycarbonate-based resin composition.

Examples of a commercial product of the amide compound (C1) include “Light Amide WH-255” (manufactured by Kyoeisha Chemical Co., Ltd., N,N′-ethylenebisstearamide), “AMIDE AP-1” (manufactured by Nippon Kasei Chemical Co., Ltd., stearamide), “SLIPAX E” (manufactured by Nippon Kasei Chemical Co., Ltd., ethylenebisstearamide), and “SLIPAX H” (manufactured by Nippon Kasei Chemical Co., Ltd., ethylenebishydroxystearamide).

### (Imide Compound (C2))

The imide compound (C2) to be used in the present invention is preferably a carbodiimide compound. The carbodiimide compound is a compound having at least one carbodiimide group in a molecule thereof, and examples thereof include a monocarbodiimide compound having one carbodiimide group in a molecule thereof and a polycarbodiimide compound having two or more carbodiimide groups in a molecule thereof. Among them, a polycarbodiimide compound is preferred from the viewpoint of suppressing the occurrence of a black streak at the time of the molding of the resin composition.

Examples of the carbodiimide compound include an aliphatic carbodiimide compound, an aromatic carbodiimide compound, a cyclic carbodiimide compound, and a compound obtained by partially carbodiimidizing an isocyanate compound (hereinafter sometimes referred to as “carbodiimide-modified compound”).

As specific examples of an aliphatic monocarbodiimide compound, there are given diisopropylcarbodiimide, dioctyldecylcarbodiimide, dicyclohexylcarbodiimide, and N,N′-dioctyldecylcarbodiimide.

As specific examples of an aliphatic polycarbodiimide compound, there are given ethylenebis(dicyclohexylcarbodiimide), hexamethylenebis(dicyclohexylcarbodiimide), poly(diisopropylcarbodiimide), poly(1,6-hexamethylenecarbodiimide), poly(4,4′-methylenebiscyclohexylcarbodiimide), poly(1,3-cyclohexylenecarbodiimide), and poly(1,4-cyclohexylenecarbodiimide).

As specific examples of an aromatic monocarbodiimide compound, there are given di-p-chlorophenylcarbodiimide, di-o-chlorophenylcarbodiimide, di-3,4-dichlorophenylcarbodiimide, di-2,5-dichlorophenylcarbodiimide, 2,6,2′,6′-tetraisopropyldiphenylcarbodiimide, N,N′-diphenylcarbodiimide, N,N′-di-o-toluylcarbodiimide, N,N′-di-2,6-dimethylphenylcarbodiimide, N-toluyl-N′-cyclohexylcarbodiimide, N,N′-bis (2,6 -diisopropylphenyl) carbodiimide, N, N′-di-2,6-di-tert-butylphenylcarbodiimide, N-toluyl-N′-phenylcarbodiimide, N,N′-di-p-nitrophenylcarbodiimide, N, N′-di-p-aminophenylcarbodiimide, N,N′-di-p-hydroxyphenylcarbodiimide, N,N′-di-o-toluylcarbodiimide, N,N′-di-p-toluylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′-tolylcarbodiimide, N,N′-di-o-ethylphenylcarbodiimide, N, N′-di-p-ethylphenylcarbodiimide, N,N′-di-o-isopropylphenylcarbodiimide, N,N′-di-p-isopropylphenylcarbodiimide, N, N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenylcarbodiimide, isopropylphenylcarbodiimide, N,N′-di-2,4,6-trimethylphenylcarbodiimide, N,N′-di-2,4,6-triisopropylphenylcarbodiimide, and N,N′-di-2,4,6-triisobutylphenylcarbodiimide.

As specific examples of an aromatic polycarbodiimide compound, there are given p-phenylenebis(o-toluylcarbodiimide), p-phenylenebis(cyclohexylcarbodiimide), p-phenylenebis(p-chlorophenylcarbodiimide), ethylenebis(diphenylcarbodiimide), poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(tolylcarbodiimide), poly(methyl-diisopropylphenylenecarbodiimide), poly(triethylphenylenecarbodiimide), and poly(triisopropylphenylenecarbodiimide).

The cyclic structure of the cyclic carbodiimide compound has one carbodiimide group (—N═C═N—), and its first nitrogen and second nitrogen are bonded to each other by a bonding group. One cyclic structure has only one carbodiimide group therein. The number of atoms in the cyclic structure is preferably from 8 to 50, more preferably from 10 to 30, still more preferably from 10 to 20. The term “number of atoms in the cyclic structure” as used herein means the number of atoms directly forming the cyclic structure. For example, in the case of an eight-membered ring, the number of atoms is 8, and in the case of a fifty-membered ring, the number of atoms is 50.

The cyclic structure is, for example, a structure represented by the following formula (c2-a):

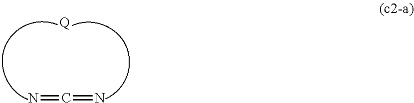

wherein Q represents a divalent to tetravalent organic group.

Examples of the isocyanate compound to be used for the compound obtained by partially carbodiimidizing an isocyanate compound (carbodiimide-modified compound) include tolylene diisocyanate, phenylene diisocyanate, 4,4′-diphenylmethane diisocyanate, polymethylene polyphenyl polyisocyanate, dimethyl biphenylene diisocyanate, dimethoxy biphenylene diisocyanate, naphthalene diisocyanate, tetrahydronaphthalene diisocyanate, tetramethylene diisocyanate, hexamethylene diisocyanate, dodecamethylene diisocyanate, trimethylhexamethylenediisocyanate, cyclohexylene diisocyanate, xylylene diisocyanate, hydrogenated xylylene diisocyanate, tetramethyl xylylene diisocyanate, lysine diisocyanate, isophorone diisocyanate, dicyclohexylmethane diisocyanate, and dimethyldicyclohexylmethane diisocyanate, and the compounds may be used alone or in combination thereof. Among the isocyanate compounds, an isocyanate compound containing 4,4′-diphenylmethane diisocyanate as a main component is preferred.

A known method can be used as a method of partially carbodiimidizing an isocyanate compound.

A compound having a molar ratio “carbodiimide group/isocyanate group” in the range of from 0.01 to 0.5 can be preferably used as the carbodiimide-modified compound, and a compound having a molar ratio in the range of from 0.1 to 0.2 is more preferred. When a compound having a molar ratio “carbodiimide group/isocyanate group” of 0.01 or more is used, its effect as a hydrolysis resistant agent is expressed, and hence the occurrence of a black streak at the time of the molding of the resin composition can be suppressed.

The imide compounds (C2) may be used alone or in combination thereof. Among those described above, the aliphatic carbodiimide compound is preferred, and the aliphatic polycarbodiimide compound is more preferred in terms of its effect as a hydrolysis resistant agent.

### (Epoxy Compound (C3))

The epoxy compound (C3) to be used in the present invention only needs to be a compound having at least one epoxy group in a molecule thereof. Examples of the epoxy compound (C3) include a glycidyl ether compound, a glycidyl ester compound, a glycidyl amine compound, a glycidyl imide compound, a cyclic epoxy compound, and an epoxidized oil.

Examples of the glycidyl ether compound may include butyl glycidyl ether, stearyl glycidyl ether, allyl glycidyl ether, phenyl glycidyl ether, o-phenylphenyl glycidyl ether, ethylene oxide lauryl alcohol glycidyl ether, ethylene oxidephenol glycidyl ether, ethylene glycol diglycidyl ether, polyethylene glycol diglycidyl ether, propylene glycol diglycidyl ether, polypropylene glycol diglycidyl ether, neopentyl glycol diglycidyl ether, polytetramethylene glycol diglycidyl ether, cyclohexanedimethanol diglycidyl ether, glycerol triglycidyl ether, trimethylolpropane triglycidyl ether, pentaerythritol polyglycidyl ether, and a bisphenol A diglycidyl ether-type epoxy resin, a bisphenol F diglycidyl ether-type epoxy resin, or a bisphenol S diglycidyl ether-type epoxy resin obtained through a condensation reaction between a bisphenol, such as 2,2-bis-(4-hydroxyphenyl)propane, 2,2-bis-(4-hydroxyphenyl)methane, or bis(4-hydroxyphenyl)sulfone, and epichlorohydrin.

Examples of the glycidyl ester compound may include benzoic acid glycidyl ester, p-toluic acid glycidyl ester, cyclohexanecarboxylic acid glycidyl ester, stearic acid glycidyl ester, lauric acid glycidyl ester, palmitic acid glycidyl ester, versatic acid glycidyl ester, oleic acid glycidyl ester, linoleic acid glycidyl ester, linolenic acid glycidyl ester, terephthalic acid diglycidyl ester, isophthalic acid diglycidyl ester, phthalic acid diglycidyl ester, naphthalenedicarboxylic acid diglycidyl ester, bibenzoic acid diglycidyl ester, methylterephthalic acid diglycidyl ester, hexahydrophthalic acid diglycidyl ester, tetrahydrophthalic acid diglycidyl ester, cyclohexanedicarboxylic acid diglycidyl ester, adipic acid diglycidyl ester, succinic acid diglycidyl ester, sebacic acid diglycidyl ester, dodecanedioic acid diglycidyl ester, octadecanedicarboxylic acid diglycidyl ester, trimellitic acid triglycidyl ester, and pyromellitic acid tetraglycidyl ester.

Examples of the glycidyl amine compound may include tetraglycidyl aminodiphenylmethane, triglycidyl-p-aminophenol, triglycidyl-m-aminophenol, diglycidylaniline, diglycidyl toluidine, N,N,N′,N′-tetraglycidyl m-xylylenediamine, diglycidyl tribromoaniline, tetraglycidylbisaminomethylcyclohexane, triglycidyl cyanurate, and triglycidyl isocyanurate.

Examples of the glycidyl imide compound may include N-glycidylphthalimide, N-glycidyl-4-methylphthalimide, N-glycidyl-4,5-dimethylphthalimide, N-glycidyl-3-methylphthalimide, N-glycidyl-3,6-dimethylphthalimide, N-glycidyl-4-ethoxyphthalimide, N-glycidyl-4-chlorophthalimide, N-glycidyl-4,5-dichlorophthalimide, N-glycidyl-3,4,5,6 tetrabromophthalimide, N-glycidyl -4-n-butyl -5-bromophthalimide, N-glycidylsuccinimide, N-glycidylhexahydrophthalimide, N-glycidyl -1,2,3,6-tetrahydrophthalimide, N-glycidylmaleimide, N-glycidyl-α,β-dimethylsuccinimide, N-glycidyl-α-ethylsuccinimide, and N-glycidyl-α-propylsuccinimide.

Examples of the cyclic epoxy compound may include 3′,4′-epoxycyclohexylmethyl-3,4-epoxycyclohexanecarboxylate, bis(3,4-epoxycyclohexylmethyl) adipate, vinylcyclohexene diepoxide, N-methyl-4,5-epoxycyclohexane-1,2-dicarboxylic acid imide, N-ethyl-4,5-epoxycyclohexane-1,2-dicarboxylic acid imide, N-phenyl -4,5 -epoxycyclohexane-1,2-dicarboxylic acid imide, N-naphthyl-4,5-epoxycyclohexane-1,2-dicarboxylic acid imide, and N-tolyl-3-methyl-4,5-epoxycyclohexane-1,2-dicarboxylic acid imide. Among them, 3′,4′-epoxycyclohexylmethyl-3,4-epoxycyclohexanecarboxylate is preferred.

Examples of the epoxidized oil may include an epoxidized natural oil and an epoxidized synthetic oil. Specific examples of the epoxidized natural oil include an epoxidized soybean oil, an epoxidized linseed oil, an epoxidized rapeseed oil, and an epoxidized whale oil. Specific examples of the epoxidized synthetic oil may include diepoxystearyl epoxyhexahydrophthalate and an epoxidized fatty acid butyl ester. Among them, the epoxidized soybean oil or the epoxidized linseed oil has a high affinity for the polycarbonate-based resin and easily expresses a hydrolysis resistance effect.

The epoxy compounds (C3) may be used alone or in combination thereof. Among those, the cyclic epoxy compound or one or more epoxidized oils selected from the group consisting of the epoxidized natural oil and the epoxidized synthetic oil are preferred as the epoxy compound (C3).

### (Acid Anhydride (C4))

The acid anhydride (C4) to be used in the present invention only needs to be a compound having at least one acid anhydride group in a molecule thereof, and examples thereof may include succinic anhydride, maleic anhydride, and phthalic anhydride. The examples may further include polymers each containing any one of the above-mentioned compounds as a monomer unit.

### (Oxazoline Compound (C5))

The oxazoline compound (C5) to be used in the present invention only needs to be a compound having at least one oxazoline group in a molecule thereof, and examples thereof may include monooxazoline, bisoxazoline, and a polyoxazoline containing an oxazoline group-containing compound as a monomer unit.

### (Oxazine Compound (C6))

The oxazine compound (C6) to be used in the present invention only needs to be a compound having at least one oxazine group in a molecule thereof, and examples thereof may include monooxazine, bisoxazine, and a polyoxazine containing an oxazine group-containing compound as a monomer unit.

### (Ketene Compound (C7))

Examples of the ketene compound (C7) to be used in the present invention include ketene represented by the following formula:

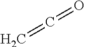

and diketene represented by the following formula:

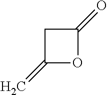

and an aldoketene obtained by substituting one hydrogen atom of the β-carbon of ketene with a substituent and a ketoketene obtained by substituting two hydrogen atoms thereof with substituents.

The hydrolysis resistant agents (C) may be used alone or in combination thereof. Among them, one or more selected from the group consisting of the amide compound (C1), the imide compound (C2), and the epoxy compound (C3) are preferred as the hydrolysis resistant agent (C) from the viewpoint of suppressing the occurrence of a black streak at the time of the molding of the resin composition. When two or more of the hydrolysis resistant agents (C) are used in combination, a combination of one or more selected from the group consisting of the amide compound (C1) and the imide compound (C2), and the epoxy compound (C3) is preferred from the same viewpoint as that described above. When those compounds are added in combination, the effects of the respective compounds as hydrolysis resistant agents are synergistically improved. Accordingly, a higher hydrolysis resistance action is obtained by a smaller addition amount of the compounds, and hence reductions in physical properties of the polycarbonate-based resin composition are suppressed.

The blending amount of the hydrolysis resistant agent (C) in the polycarbonate-based resin composition of the present invention is 0.02 part by mass or more to 5.0 parts by mass or less, preferably 0.05 part by mass or more to 1.0 part by mass or less, more preferably 0.1 part by mass or more to 0.5 part by mass or less with respect to 100 parts by mass of the polycarbonate-based resin (A). In the case where the blending amount of the hydrolysis resistant agent (C) is less than 0.02 part by mass with respect to 100 parts by mass of the polycarbonate-based resin (A), the occurrence of a black streak cannot be suppressed at the time of the molding of the resin composition. In the case where the blending amount is more than 5.0 parts by mass, such an inconvenience as described below occurs: a gas is produced at the time of the molding of the resin composition to adhere to a die. In addition, the latter case is not preferred in terms of economical efficiency.

A case in which the blending amount of the hydrolysis resistant agent (C) is 0.05 part by mass or more is preferred because a black streak occurring in a molded body molded at a constant back pressure is further suppressed. In addition, a case in which the blending amount is 0.1 part by mass or more is more preferred because a black streak occurring in a molded body molded at a higher back pressure is also further suppressed.

A case in which the blending amount of the hydrolysis resistant agent (C) is 0.02 part by mass or more is preferred because the occurrence of a silver streak is also further suppressed.

When the amide compound (C1) is used as the hydrolysis resistant agent (C), the blending amount of the amide compound (C1) with respect to 100 parts by mass of the polycarbonate-based resin (A) is preferably 0.1 part by mass or more, more preferably 0.2 part by mass or more, still more preferably 0.3 part by mass or more, and is preferably 5.0 parts by mass or less, more preferably 3.0 parts by mass or less, still more preferably 1.0 part by mass or less, still further more preferably 0.5 part by mass or less.

When the imide compound (C2) is used as the hydrolysis resistant agent (C), the blending amount of the imide compound (C2) with respect to 100 parts by mass of the polycarbonate-based resin (A) is preferably 0.1 part by mass or more, more preferably 0.2 part by mass or more, still more preferably 0.3 part by mass or more, and is preferably 5.0 parts by mass or less, more preferably 3.0 parts by mass or less, still more preferably 1.0 part by mass or less, still further more preferably 0.5 part by mass or less.

When the epoxy compound (C3) is used as the hydrolysis resistant agent (C), the blending amount of the epoxy compound (C3) with respect to 100 parts by mass of the polycarbonate-based resin (A) is preferably 0.02 part by mass or more, more preferably 0.03 part by mass or more, still more preferably 0.05 part by mass or more, and is preferably 0.5 part by mass or less, more preferably 0.3 part by mass or less, still more preferably 0.2 part by mass or less.

A preferred blending amount range in the case where two or more of the hydrolysis resistant agents (C) are used in combination is also the same as that described above.

### <Antioxidant (D)>

The polycarbonate-based resin composition of the present invention preferably further comprises an antioxidant (D). When the polycarbonate-based resin composition comprises the antioxidant, the oxidative deterioration of the polycarbonate-based resin composition at the time of its melting can be prevented, and hence its coloring or the like due to the oxidative deterioration can be prevented. For example, a phosphorus-based antioxidant and/or a phenol-based antioxidant is suitably used as the antioxidant, and a phosphorus-based antioxidant is more preferred.

Examples of the phosphorus-based antioxidant include triphenyl phosphite, diphenylnonyl phosphite, diphenyl(2-ethylhexyl) phosphite, tris(2,4-di-t-butylphenyl) phosphite, tris(nonylphenyl) phosphite, diphenylisooctyl phosphite, 2,2′-methylenebis(4,6-di-t-butylphenyl)octyl phosphite, diphenylisodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-t-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-t-butylphenyl)ditridecyl phosphite,bis(2,4-di-t-butylphenyl)pentaerythritoldiphosphite, bis(2,6-di-t-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, 1,1,3-tris(2-methyl-4-di-tridecyl phosphite-5-t-butylphenyl)butane, 3,4,5,6-dibenzo-1,2-oxaphosphane, triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl(α-ethylcarboxyethyl)phosphine, tris(p-chlorophenyl)phosphine, tris(p-fluorophenyl)phosphine, benzyldiphenylphosphine, diphenyl(β-cyanoethyl)phosphine, diphenyl(p-hydroxyphenyl)phosphine, diphenyl-(1,4-dihydroxyphenyl)-2-phosphine, and phenylnaphthylbenzylphosphine.

Examples of the phosphorus-based antioxidant may include commercially available products, such as Irgafos 168 (manufactured by BASF Japan, trademark), Irgafos 12 (manufactured by BASF Japan, trademark), Irgafos 38 (manufactured by BASF Japan, trademark), ADK STAB 2112 (manufactured by ADEKA Corporation, trademark), ADK STAB C (manufactured by ADEKA Corporation, trademark), ADK STAB 329K (manufactured by ADEKA Corporation, trademark), ADK STAB PEP36 (manufactured by ADEKA Corporation, trademark), JC-263 (manufactured by Johoku Chemical Co., Ltd., trademark), Sandstab P-EPQ (manufactured by Clariant, trademark), Weston 618 (manufactured by GE, trademark), Weston 619G (manufactured by GE, trademark), Weston 624 (manufactured by GE, trademark), and Doverphos S-9228PC (manufactured by Dover Chemical Corporation, trademark).

Examples of the phenol-based antioxidant include hindered phenols, such as n-octadecyl-3-(3,5-di-t-butyl-4-hydroxyphenyl)propionate, 2,6-di-t-butyl-4-methylphenol, 2,2′-methylenebis(4-methyl-6-t-butylphenol), and pentaerythrityl-tetrakis[3-(3,5-di-t-butyl-4-hydroxyphenyl)propionate].

Among those antioxidants, antioxidants each having a pentaerythritol diphosphite structure, such as bis(2,6-di-tert-butyl-4-methylphenyl)pentaerythritol diphosphite and bis(2,4-di-tert-butylphenyl)pentaerythritol diphosphite, and triphenylphosphine are preferred.

Examples of the phenol-based antioxidant may include commercially available products, such as Irganox 1010 (manufactured by BASF Japan, trademark), Irganox 1076 (manufactured by BASF Japan, trademark), Irganox 1330 (manufactured by BASF Japan, trademark), Irganox 3114 (manufactured by BASF Japan, trademark), Irganox 3125 (manufactured by BASF Japan, trademark), BHT (manufactured by Takeda Pharmaceutical Company, trademark), Cyanox 1790 (manufactured by American Cyanamid Company, trademark), and Sumilizer GA-80 (manufactured by Sumitomo Chemical Co., Ltd., trademark).

The antioxidants (D) may be used alone or in combination thereof.

The blending amount of the antioxidant (D) in the polycarbonate-based resin composition of the present invention is preferably 0.001 part by mass or more to 0.5 part by mass or less, preferably 0.01 part by mass or more to 0.3 part by mass or less, more preferably 0.05 part by mass or more to 0.3 part by mass or less with respect to 100 parts by mass of the polycarbonate-based resin (A).

### <Other Additive>

The polycarbonate-based resin composition of the present invention may comprise any other additive to the extent that the effects of the present invention are not impaired. Examples of the other additive may include a UV absorber, a flame retardant, a flame retardant aid, a release agent, a reinforcing material, a filler, an elastomer for improving impact resistance, and a dye.

Examples of the UV absorber include a benzotriazole-based compound, a benzoxazinone-based compound, a salicylate-based compound, a malonate ester-based compound, an oxalanilide-based compound, a triazine-based compound, a benzophenone-based compound, and a cyanoacrylate-based compound. Those UV absorbers maybe used alone or in combination thereof.

The polycarbonate-based resin composition of the present invention is obtained by: blending the above-mentioned respective components at the above-mentioned ratios and various optional components to be used as required at appropriate ratios; and kneading the components.

The blending and the kneading may be performed by a method involving premixing with a typically used apparatus, such as a ribbon blender or a drum tumbler, and using, for example, a Henschel mixer, a Banbury mixer, a single-screw extruder, a twin-screw extruder, a multi-screw extruder, or a Ko-kneader. In normal cases, a heating temperature at the time of the kneading is appropriately selected from the range of 240° C. or more to 320° C. or less. An extruder, in particular a vented extruder is preferably used as the melt-kneading molding machine.

### [Molded Article]

A molded article of the present invention comprises the polycarbonate-based resin composition of the present invention. The molded article can be produced through molding with the melt-kneading molding machine, or by using a pellet obtained from the composition as a raw material through molding by an injection molding method, an injection compression molding method, an extrusion molding method, a blow molding method, a press molding method, a vacuum molding method, an expansion molding method, and the like. In particular, the resultant pellet is preferably used to produce a molded article by the injection molding method or the injection compression molding method.

In the production of the molded article containing the polycarbonate-based resin composition, from the viewpoints of preventing the inclusion of moisture in a production process and suppressing the occurrence of a black streak at the time of the molding of the resin composition, the molded article is preferably produced under such a condition that the residence time of the polycarbonate-based resin composition in the molding machine is shortened. A preferred mode of a method of producing the molded article based on the injection molding method or the injection compression molding method is, for example, as described below.

In the production of the molded article based on the injection molding method or the injection compression molding method, a pellet formed of the polycarbonate-based resin composition is preferably melted and plasticized with an injection molding machine provided with a screw. From the viewpoint of suppressing the occurrence of a black streak, the molding machine is preferably of a low-compression screw type, and the shape of the screw is preferably a full-flighted screw.

The back pressure of the screw is preferably set within a low range from the viewpoints of suppressing shear heating and suppressing the compression of the resin composition to suppress the occurrence of a black streak. The back pressure, which can be appropriately selected in accordance with, for example, an apparatus to be used, falls within the range of, for example, from 2 MPa to 10 MPa. From the same viewpoints, the number of revolutions of the screw is also preferably set within a low range, and falls within the range of, for example, from 60 rpm to 80 rpm.

A temperature (cylinder temperature) at the time of the molding is preferably set to, for example, from 260° C. to 320° C. from the viewpoint of reducing the viscosity of the polycarbonate-based resin composition to smooth its flow.

The molded article of the present invention can be suitably used in, for example, parts for electrical and electronic equipment, such as a television, a radio-cassette player, a video camera, a videotape recorder, an audio player, a DVD player, an air conditioner, a cellular phone, a display, a computer, a register, an electronic calculator, a copying machine, a printer, or a facsimile, or casings for the electrical and electronic equipment, parts for the interior and exterior of lighting equipment, parts for the interior and exterior of a vehicle, food trays, and eating utensils. In particular, the molded article is suitable as a material for a casing for a cellular phone, a mobile personal computer, a digital camera, a video camera, an electric tool, or the like.

### EXAMPLES

Examples of the present invention are further described. The present invention is by no means limited by those examples. Measurement and evaluations in the respective examples were performed by the following methods.

### (Measurement of Chloroformate Group Concentration)

Measurement was performed on the basis of a chlorine ion concentration with reference to JIS-K-8203 by using oxidation-reduction titration and silver nitrate titration.

### (Measurement of Weight-Average Molecular Weight (Mw))

A weight-average molecular weight (Mw) was measured as a molecular weight in terms of standard polystyrene (weight-average molecular weight: Mw) by GPC [column: TOSOH TSK-GEL MULTIPORE HXL-M (two)+Shodex KF801 (one), temperature: 40° C., flow rate: 1.0 mL/min, detector: RI] through the use of tetrahydrofuran as a developing solvent.

### (Average Chain Length and Content of Polydimethylsiloxane)

The average chain length and content of a polydimethylsiloxane were calculated by NMR measurement from the integrated value ratio of a methyl group of the polydimethylsiloxane.

### <Quantification Method for Average Chain Length of Polydimethylsiloxane>

¹H-NMR Measurement Conditions
NMR apparatus: ECA500 manufactured by JEOL Resonance Co., Ltd.
Probe: 50TH5AT/FG2
Observed range: −5 ppm to 15 ppm
Observation center: 5 ppm
Pulse repetition time: 9 sec
Pulse width: 45°
NMR sample tube: 5φ
Sample amount: 30 mg to 40 mg
Solvent: deuterochloroform
Measurement temperature: room temperature
Number of scans: 256 times
In the Case of Allylphenol-terminated Polydimethylsiloxane
A: an integrated value of a methyl group in a dimethylsiloxane moiety observed around δ −0.02 to δ 0.5
B: an integrated value of a methylene group in allylphenol observed around δ 2.50 to δ 2.75

Chain length of polydimethylsiloxane=(A/6)/(B/4)
In the Case of Eugenol-terminated Polydimethylsiloxane
A: an integrated value of a methyl group in a dimethylsiloxane moiety observed around δ −0.02 to δ 0.5
B: an integrated value of a methylene group in eugenol observed around δ 2.40 to δ 2.70

Chain length of polydimethylsiloxane=(A/6)/(B/4)

### <Quantification Method for Content of Polydimethylsiloxane in PC-PDMS Copolymer>

Quantification Method for Copolymerization Amount of Polydimethylsiloxane in PTBP-terminated Polycarbonate obtained by copolymerizing Allylphenol-terminated Polydimethylsiloxane
NMR apparatus: ECA-500 manufactured by JEOL Resonance Co., Ltd.
Probe: TH5 corresponding to 5φ NMR sample tube
Observed range: −5 ppm to 15 ppm
Observation center: 5 ppm
Pulse repetition time: 9 sec
Pulse width: 45°
Number of scans: 256 times
NMR sample tube: 5φ
Sample amount: 30 mg to 40 mg
Solvent: deuterochloroform
Measurement temperature: room temperature
A: an integrated value of a methyl group in a BPA moiety observed around δ 1.5 to δ 1.9
B: an integrated value of a methyl group in a dimethylsiloxane moiety observed around δ −0.02 to δ 0.3
C: an integrated value of a butyl group in a p-tert-butylphenyl moiety observed around δ 1.2 to δ 1.4

a=A/6

b=B/6

c=C/9

T=a+b+c

f=a/T×100

g=b/T×100

h=c/T×100

TW=f×254+g×74.1+hx149

PDMS(wt %)=g×74.1/TW×100

### (Measurement of Viscosity-Average Molecular Weight (Mv))

A viscosity-average molecular weight (Mv) was calculated from the following equation (Schnell's equation) by using a limiting viscosity [η] determined through the measurement of the viscosity of a methylene chloride solution (concentration: g/L) at 20° C. with an Ubbelohde-type viscometer.

[η]=1.23×10⁻⁵×Mv^{0.83}

### (Measurement of Concentration of Moisture in White Pigment)

White pigment powder serving as a sample was left to stand at a constant temperature of 25° C. and a constant relative humidity of 55% for 24 hours to be brought into an equilibrium state. After that, the moisture concentration of 0.3 g of the sample at a temperature of from 0° C. to 300° C. was measured with a Karl-Fischer moisture-measuring apparatus “COULOMETRIC MOISTURE METER CA100” and a moisture-vaporizing apparatus “VA-100” attached thereto (both the apparatus were manufactured by Dia Instruments Co., Ltd.) at a nitrogen flow rate of about 250 mL. After that, a moisture concentration detected and integrated at from 0° C. to 120° C. was subtracted from the measured value, and the resultant value was defined as the amount of chemically bonded water held at 120° C. or more (to 300° C.).

### Synthesis Example 1

### Synthesis of Polycarbonate Oligomer

Sodium dithionite was added in an amount of 2,000 ppm by mass with respect to bisphenol A to be dissolved later to 5.6 mass % aqueous sodium hydroxide, and bisphenol A was dissolved in the mixture so that the concentration of bisphenol A was 13.5 mass %. Thus, a solution of bisphenol A in aqueous sodium hydroxide was prepared.

The solution of bisphenol A in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of a reaction liquid was kept at 40° C. or less by passing cooling water through the jacket.

The reaction liquid that had exited the tubular reactor was continuously introduced into a baffled vessel-type reactor having an internal volume of 40 L provided with a sweptback blade, and then the solution of bisphenol A in aqueous sodium hydroxide, 25 mass % aqueous sodium hydroxide, water, and a 1 mass % aqueous solution of triethylamine were further added to the reactor at flow rates of 2.8 L/hr, 0.07 L/hr, 17 L/hr, and 0.64 L/hr, respectively, to thereby perform a reaction. The reaction liquid flowing out of the vessel-type reactor was continuously taken out, and then an aqueous phase was separated and removed by leaving the liquid at rest, followed by the collection of a methylene chloride phase.

The concentration of the polycarbonate oligomer thus obtained was 318 g/L and the concentration of a chloroformate group thereof was 0.75 mol/L. The weight-average molecular weight (Mw) of the oligomer was 1,190.

### Production Example 1

### Production of Polycarbonate-Polydimethylsiloxane Copolymer (PC-PDMS 1)

15 L of the polycarbonate oligomer solution produced in Synthesis Example 1, 8.9 L of methylene chloride, 307 g of a 2-allylphenol terminal-modified polydimethylsiloxane (PDMS-1) in which the average chain length of a polydimethylsiloxane block was 90, and 8.8 mL of triethylamine were loaded into a 50-liter vessel-type reactor including a baffle board, a paddle-type stirring blade, and a cooling jacket. 1,389 g of 6.4 mass % aqueous sodium hydroxide was added to the mixture under stirring to perform a reaction between the polycarbonate oligomer and the 2-allylphenol terminal-modified polydimethylsiloxane for 10 minutes.

A solution of p-t-butylphenol (PTBP) in methylene chloride (prepared by dissolving 129 g of PTBP in 2.0 L of methylene chloride) and a solution of bisphenol A in aqueous sodium hydroxide (prepared by dissolving 1,147 g of bisphenol A in an aqueous solution prepared by dissolving 581 g of sodium hydroxide and 2.3 g of sodium dithionite in 8.5 L of water) were added to the polymerization liquid to perform a polymerization reaction for 50 minutes. 10 L of methylene chloride was added to the resultant for dilution and the mixture was stirred for 10 minutes. After that, the mixture was separated into an organic phase containing a polycarbonate-polydimethylsiloxane copolymer, and an aqueous phase containing excess amounts of bisphenol A and sodium hydroxide, and the organic phase was isolated.

The solution of the polycarbonate-polydimethylsiloxane copolymer in methylene chloride thus obtained was sequentially washed with 0.03 mol/L aqueous sodium hydroxide and 0.2 mol/L hydrochloric acid in amounts of 15 vol % each with respect to the solution. Next, the solution was repeatedly washed with pure water until an electric conductivity in an aqueous phase after the washing became 0.01 μS/m or less. The solution of the polycarbonate-polydimethylsiloxane copolymer in methylene chloride obtained by the washing was concentrated and pulverized, and the resultant flake was dried under reduced pressure at 120° C.

The polycarbonate-polydimethylsiloxane copolymer (PC-PDMS 1) obtained as described above had a polydimethylsiloxane residue amount determined by ¹-NMR measurement of 6.0 mass %, a viscosity number measured in conformity with ISO 1628-4 (1999) of 47.4, and a viscosity-average molecular weight (Mv) of 17,650.

### Examples 1 to 11 and Comparative Examples 1 to 3

Components shown in Table 1 were blended in blending amounts shown in the table. The mixture was supplied to a vented twin-screw extruder (“TEM-35B” manufactured by Toshiba Machine Co., Ltd.), and was melt-kneaded at a screw revolution number of 250 rpm, an ejection amount of 25 kg/hr, and a barrel preset temperature of 280° C. (actual extrusion temperature: 295° C. to 300° C.) to provide a pellet.

TABLE 1

| | | | Examples | | | | | |
|---|---|---|---|---|---|---|---|---|
| | | | 1 | 2 | 3 | 4 | 5 | 6 |
| Resin composition | (A1) PC-PDMS copolymer | Parts by | 100 | 100 | 100 | 100 | 100 | 100 |
| | | mass | | | | | | |
| | (B-1) Titanium oxide (CR-63) | Parts by | 2.0 | 2.0 | 2.0 | 2.0 | 2.0 | 2.0 |
| | | mass | | | | | | |
| | (B-2) Titanium oxide | Parts by | | | | | | |
| | (PF-728) | mass | | | | | | |
| | (C1) Amide compound | Parts by | 0.20 | 0.40 | | | | |
| | (Light Amide WH-255) | mass | | | | | | |
| | (C2-1) Carbodiimide | Parts by | | | 0.20 | 0.40 | | |
| | compound (CARBODILITE | mass | | | | | | |
| | HMV-15CA) | | | | | | | |
| | (C2-2) Carbodiimide | Parts by | | | | | 0.20 | 0.40 |
| | compound (CARBODILITE | mass | | | | | | |
| | LA-1) | | | | | | | |
| | (C3-1) Epoxidized linseed oil | Parts by | | | | | | |
| | (SANSO CIZER E-9000H) | mass | | | | | | |
| | (C3-2) Cyclic epoxy | Parts by | | | | | | |
| | compound | mass | | | | | | |
| | (CELLOXIDE 2021P) | | | | | | | |
| | Alkoxy silicone (BY16-161) | Parts by | | | | | | |
| | | mass | | | | | | |
| | (D) Antioxidant (Irgafos168) | Parts by | 0.10 | 0.10 | 0.10 | 0.10 | 0.10 | 0.10 |
| | | mass | | | | | | |
| Kneading condition | Temperature setting (flat) | ° C. | 280 | 280 | 280 | 280 | 280 | 280 |
| | Charge amount | kg/hr | 25 | 25 | 25 | 25 | 25 | 25 |
| | Number of revolutions | rpm | 250 | 250 | 250 | 250 | 250 | 250 |
| Kneading | Current | A | 35.0 | 35.0 | 39.0 | 34.0 | 35.0 | 35.0 |
| performance | Extrusion temperature | ° C. | 312 | 311 | 305 | 313 | 313 | 308 |
| | Resin pressure | kg/cm² | 1.2 | 1.0 | 1.4 | 1.0 | 1.0 | 1.0 |

| | | | Examples | | | | |
|---|---|---|---|---|---|---|---|
| | | | 7 | 8 | 9 | 10 | 11 |
| Resin | (A1) PC-PDMS copolymer | Parts by mass | 100 | 100 | 100 | 100 | 100 |
| composition | (B-1) Titanium oxide (CR-63) | Parts by mass | | | 2.0 | 2.0 | 2.0 |
| | (B-2) Titanium oxide (PF-728) | Parts by mass | 2.0 | 2.0 | | | |
| | (C1) Amide compound | Parts by mass | 0.20 | 0.40 | | | |
| | (Light Amide WH-255) | | | | | | |
| | (C2-1) Carbodiimide compound | Parts by mass | | | | | |
| | (CARBODILITE HMV-15CA) | | | | | | |
| | (C2-2) Carbodiimide compound | Parts by mass | | | | | |
| | (CARBODILITE LA-1) | | | | | | |
| | (C3-1) Epoxidized linseed oil | Parts by mass | | | 0.10 | 0.20 | |
| | (SANSO CIZER E-9000H) | | | | | | |
| | (C3-2) Cyclic epoxy compound | Parts by mass | | | | | 0.10 |
| | (CELLOXIDE 2021P) | | | | | | |
| | Alkoxy silicone (BY16-161) | Parts by mass | | | | | |
| | (D) Antioxidant (Irgafos168) | Parts by mass | 0.10 | 0.10 | 0.10 | 0.10 | 0.10 |
| Kneading | Temperature setting (flat) | ° C. | 280 | 280 | | | 280 |
| condition | Charge amount | kg/hr | 25 | 25 | | | 25 |
| | Number of revolutions | rpm | 250 | 250 | | | 250 |
| Kneading | Current | A | 35.0 | 35.0 | | | 35.0 |
| performance | Extrusion temperature | ° C. | 313 | 309 | | | 310 |
| | Resin pressure | kg/cm² | 1.1 | 1.1 | | | 1.1 |

| | | | Comparative Examples | | |
|---|---|---|---|---|---|
| | | | 1 | 2 | 3 |
| Resin | (A1) PC-PDMS copolymer | Parts by mass | 100 | 100 | 100 |
| composition | (B-1) Titanium oxide (CR-63) | Parts by mass | 2.0 | | 2.0 |
| | (B-2) Titanium oxide (PF-728) | Parts by mass | | 2.0 | |
| | (C1) Amide compound | Parts by mass | | | |
| | (Light Amide WH-255) | | | | |
| | (C2-1) Carbodiimide compound | Parts by mass | | | |
| | (CARBODILITE HMV-15CA) | | | | |
| | (C2-2) Carbodiimide compound | Parts by mass | | | |
| | (CARBODILITE LA-1) | | | | |
| | (C3-1) Epoxidized linseed oil | Parts by mass | | | |
| | (SANSO CIZER E-9000H) | | | | |
| | (C3-2) Cyclic epoxy compound | Parts by mass | | | |
| | (CELLOXIDE 2021P) | | | | |
| | Alkoxy silicone (BY16-161) | Parts by mass | | | 0.40 |
| | (D) Antioxidant (Irgafos168) | Parts by mass | 0.10 | 0.10 | 0.10 |
| Kneading | Temperature setting (flat) | ° C. | 280 | 280 | 280 |
| condition | Charge amount | kg/hr | 25 | 25 | 25 |
| | Number of revolutions | rpm | 250 | 250 | 250 |
| Kneading | Current | A | 35.0 | 35.0 | 35.0 |
| performance | Extrusion temperature | ° C. | 319 | 311 | 312 |
| | Resin pressure | kg/cm² | 1.0 | 1.1 | 1.1 |

The components used in the table are as described below.

(A1) PC-PDMS copolymer: the PC-PDMS 1 obtained in Production Example 1 (Mv: 17,650)

(B-1) Titanium oxide : “CR-63” manufactured by Ishihara Sangyo Kaisha, Ltd. (crystal structure: rutile type, titanium dioxide subjected to a surface treatment with 1% of silica-alumina and 0.5% of dimethyl silicone, average particle diameter: 0.21 μm, amount of chemically bonded water: 2,600 ppm by mass)

(B-2) Titanium oxide : “PF-728” manufactured by Ishihara Sangyo Kaisha, Ltd. (crystal structure: rutile type, titanium dioxide subjected to a surface treatment with 7% of silica-alumina and 2% of a polysiloxane, average particle diameter: 0.21 μm, amount of chemically bonded water: 4,500 ppm by mass)

(C1) Amide compound: “Light Amide WH-255” (N,N′-ethylenebisstearamide) manufactured by Kyoeisha Chemical Co., Ltd.

(C2-1) Carbodiimide compound: “CARBODILITE HMV-15CA” manufactured by Nisshinbo Chemical Inc.

(C2-2) Carbodiimide compound: “CARBODILITE LA-1” manufactured by Nisshinbo Chemical Inc.

(C3-1) Epoxidized linseed oil: “SANSO CIZER E-9000H” manufactured by New Japan Chemical Co., Ltd.

(C3-2) Cyclic epoxy compound: “CELLOXIDE 2021P” (3′,4′-epoxycyclohexylmethyl-3,4-epoxycyclohexanecarboxylate) manufactured by Daicel Corporation

(D) Antioxidant: “IRGAFOS 168” (tris-(2,4-di-t-butylphenyl) phosphite) manufactured by BASF Japan

Alkoxy silicone (compound that is not the hydrolysis resistant agent (C)): “BY-16-161” manufactured by Dow Corning Toray Co., Ltd. (silicone containing a methoxysilyl group in which a methoxy group is bonded to a silicon atom through a divalent hydrocarbon group)

The following evaluations were performed by using the resultant pellets. The results are shown in Table 2.

### (1) Observation of Molded Article Appearance Failures (Silver Streak and Black Streak)

Each of the pellets was preliminarily dried with a dryer at 120° C. for 8 hours, and then injection molding was performed with an injection molding machine (“ES1000” manufactured by Nissei Plastic Industrial Co., Ltd.) under the following conditions for 20 shots. The appearance of the resultant molded article was visually observed, and was evaluated in accordance with the following criteria.

Specifically, each of the pellets was supplied from a hopper into a cylinder, and while the number of revolutions of a screw for plasticizing and kneading the pellet was set to 80 rpm, and the setting of the back pressure of the screw was changed in six stages, i.e., 4 MPa, 10 MPa, 20 MPa, 30 MPa, 40 MPa, and 50 MPa, the injection molding was performed for each example in order of increasing screw back pressure.

As the screw back pressure is increased, a black streak-like appearance failure is more liable to occur. Meanwhile, in general, a silver streak is less liable to occur as the plasticization is stabilized (the back pressure becomes higher). In view of the foregoing, a black streak evaluation was performed for each of the molded articles corresponding to all the conditions under which the injection molding was performed, and a silver streak evaluation was performed only at the lowest screw back pressure (4 MPa) at which the plasticization of materials for any such molded article in the molding machine was stabilized. In the table, the evaluation “A” means that a silver streak and a black streak-like pattern hardly occur, and hence an evaluation result is satisfactory.

A: A silver streak or a black streak-like pattern is not observed on the surface of a molded article at all.

B: A silver streak or a black streak-like pattern is observed on the surface of a molded article.

### (2) Observation of Black Streak

A frame having the same size as that of each of the molded articles was opened in a wooden plate having a size sufficiently larger than that of the molded article, and the molded article was fit into the frame. One side of the molded article was irradiated with light from a 110 V×1.5 kW lamp, and the molded article was observed from the side opposite thereto and evaluated in accordance with the following criteria. In the table, a larger value for the screw back pressure at which the evaluation “A” is obtained means that a black streak-like pattern more hardly occurs, and hence an evaluation result is more satisfactory.

A: No black streak-like pattern is observed.

B: A black streak-like pattern is observed.

### (Injection Molding Conditions)

Die: flat die measuring 80 mmW by 120 mmH by 2 mmt

Die temperature: 80° C.

Cylinder temperature setting: each part was set at 290° C./280° C./270° C./250° C. in the order of NH/H1/H2/H3 from the nozzle side
(3) Izod Impact Strength

A notch was made in a test piece measuring 63 mm by 13 mm by 3.2 mm (about ⅛ inch) thick by post-processing. The notched Izod impact strengths of the resultant test piece at −30° C., −20° C., 0° C., and 23° C. were measured in conformity with ASTM Standard D-256.

### (4) Fluidity

### (MFR)

A MFR (g/10 min) at a temperature of 280° C. and a load of 2.16 kg was measured in conformity with ASTM Standard D-1238.

### (MVR)

A MVR (cm³/10 min) at a temperature of 300° C. and a load of 2.16 kg was measured in conformity with ISO-1133 by using MFR METER UNIT E manufactured by Yasuda Seiki Seisakusho, Ltd.

### (5) Tensile Characteristics (Yield Strength, Breaking Strength, Tensile Modulus, and Elongation at Break)

A test piece measuring 126 mm by 13 mm by 3.2 mm thick was used, and its tensile modulus under the condition of 1 mm/min, and its yield strength, breaking strength, and elongation at break under the condition of 50 mm/min were measured in conformity with ISO-527-1 and 2. Larger numerical values therefor mean that the tensile characteristics of the test piece are more satisfactory.

### (6) Bending Characteristics (Bending Strength and Bending Modulus)

A test piece measuring 100 mm by 10 mm by 4 mm thick was used, and its bending strength and bending modulus were measured in conformity with ISO-178 under the conditions of a temperature of 23 ° C. and a bending rate of 2 mm/min. Larger numerical values therefor mean that the bending characteristics of the test piece are more satisfactory.

### (7) Heat Distortion Temperature (HDT)

A test piece measuring 126 mm by 13 mm by 3.2 mm thick was used, and its heat distortion temperature (HDT) was measured in conformity with ASTM Standard D-648 at a load of 1.83 MPa. The HDT serves as a guideline on heat resistance, and a judgment criterion therefor is as follows: a HDT of 120° C. or more means that the test piece has sufficient heat resistance.

TABLE 2

| | | | | | Examples | | | | | |
|---|---|---|---|---|---|---|---|---|---|---|
| | | | | | 1 | 2 | 3 | 4 | 5 | 6 |
| Molded article | Silver streak | Screw back | 4 | MPa | A | A | A | A | A | A |
| appearance | Black streak | pressure at time of | 4 | MPa | A | A | A | A | A | A |
| | | melt kneading of | 10 | MPa | A | A | A | A | A | A |
| | | injection molding | 20 | MPa | A | A | A | A | A | A |
| | | | 30 | MPa | B | A | B | A | A | A |
| | | | 40 | MPa | | A | | A | A | A |
| | | | 50 | MPa | | | | | | A |

| Result of | Screw back | 4 | | MPa | A | A | A | A | A | A |
|---|---|---|---|---|---|---|---|---|---|---|
| observation | pressure at time of | 10 | | MPa | A | A | A | A | A | A |
| of black | melt kneading of | 20 | | MPa | B | A | B | A | A | A |
| streak | injection molding | 30 | | MPa | B | A | B | B | B | A |
| | | 40 | | MPa | | B | | B | B | A |
| | | 50 | | MPa | | | | | | B |
| Fluidity | MFR | 280° | C. | g/10 min | 15.9 | 17.6 | 15.0 | 17.3 | 16.2 | 18.6 |
| | MVR | 300° | C. | cm³/10 min | 16.9 | 20.0 | 16.5 | 19.5 | 17.0 | 19.0 |
| Impact | Notched Izod | 23° | C. | kJ/m² | 67.1 | 66.5 | 66.2 | 64.0 | 66.3 | 64.3 |
| characteristic | impact strength | 0° | C. | kJ/m² | 64.3 | 61.8 | 62.0 | 61.2 | 63.1 | 61.7 |
| | | −20° | C. | kJ/m² | 59.0 | 57.8 | 58.2 | 56.5 | 57.5 | 55.8 |
| | | −30° | C. | kJ/m² | 55.0 | 54.7 | 53.5 | 52.1 | 54.5 | 53.3 |
| Tensile | Yield strength | 23° | C. | MPa | 56.2 | 56.7 | 56.8 | 57.1 | 55.6 | 56.2 |
| characteristic | Breaking strength | | | MPa | 61.2 | 56.6 | 60.5 | 58.2 | 60.2 | 58.4 |
| | Tensile modulus | | | MPa | 2,058 | 2,086 | 2,075 | 2,088 | 2,070 | 2,097 |
| | Elongation at | | | % | 99.7 | 84.2 | 90.5 | 82.5 | 92.5 | 90.1 |
| | break | | | | | | | | | |
| Bending | Bending strength | 23° | C. | MPa | 80.4 | 81.2 | 81.5 | 82.5 | 81.0 | 82.2 |
| characteristic | Bending modulus | | | MPa | 2,035 | 2,056 | 2,040 | 2,066 | 2,050 | 2,093 |
| Thermal | HDT | 1.8 | MPa | ° C. | 123.9 | 122.4 | 123.5 | 124.0 | 123.0 | 124.2 |
| characteristic | | | | | | | | | | |

| | | | | | Examples | | | | |
|---|---|---|---|---|---|---|---|---|---|
| | | | | | 7 | 8 | 9 | 10 | 11 |
| Molded article appearance | Silver streak | Screw back | 4 | MPa | A | A | A | A | A |
| | Black streak | pressure at time | 4 | MPa | A | A | A | A | A |
| | | of melt kneading | 10 | MPa | A | A | A | A | A |
| | | of injection | 20 | MPa | A | A | A | A | A |
| | | molding | 30 | MPa | A | A | A | A | A |
| | | | 40 | MPa | | A | A | A | A |
| | | | 50 | MPa | | | | A | |

| Result of observation | Screw back | 4 | | MPa | A | A | A | A | A |
|---|---|---|---|---|---|---|---|---|---|
| of black streak | pressure at time | 10 | | MPa | A | A | A | A | A |
| | of melt kneading | 20 | | MPa | A | A | A | A | A |
| | of injection | 30 | | MPa | B | A | A | A | A |
| | molding | 40 | | MPa | | B | B | A | B |
| | | 50 | | MPa | | | | A | |
| Fluidity | MFR | 280° | C. | g/10 min | 15.4 | 17.3 | 15.9 | 17.5 | 16.0 |
| | MVR | 300° | C. | cm³/10 min | 16.1 | 19.7 | 13.7 | 15.5 | 16.6 |
| Impact characteristic | Notched Izod | 23° | C. | kJ/m² | 66.3 | 67.4 | 67.2 | 68.3 | 68.6 |
| | impact strength | 0° | C. | kJ/m² | 64.2 | 62.8 | 64.0 | 65.1 | 65.0 |
| | | −20° | C. | kJ/m² | 59.1 | 58.2 | 59.0 | 57.0 | 57.7 |
| | | −30° | C. | kJ/m² | 55.2 | 55.5 | 56.0 | 55.2 | 56.1 |
| Tensile characteristic | Yield strength | 23° | C. | MPa | 56.3 | 56.8 | 56.1 | 55.1 | 56.5 |
| | Breaking strength | | | MPa | 61.3 | 59.4 | 61.5 | 62.0 | 59.6 |
| | Tensile modulus | | | MPa | 2,041 | 2,081 | 2,040 | 2,075 | 2,126 |
| | Elongation at | | | % | 98.1 | 92.1 | 100.5 | 95.2 | 93.6 |
| | break | | | | | | | | |
| Bending | Bending strength | 23° | C. | MPa | 81.3 | 82.2 | 80.4 | 82.5 | 81.6 |
| characteristic | Bending modulus | | | MPa | 2,027 | 2,046 | 2,040 | 2,080 | 2,116 |
| Thermal | HDT | 1.8 | MPa | ° C. | 124.1 | 122.7 | 123.2 | 122.5 | 122.9 |
| characteristic | | | | | | | | | |

| | | | | | Comparative Examples | | |
|---|---|---|---|---|---|---|---|
| | | | | | 1 | 2 | 3 |
| Molded article appearance | Silver streak | Screw back | 4 | MPa | B | B | B |
| | Black streak | pressure at time of | 4 | MPa | B | B | B |
| | | melt kneading of | 10 | MPa | | B | |
| | | injection molding | 20 | MPa | | | |
| | | | 30 | MPa | | | |
| | | | 40 | MPa | | | |
| | | | 50 | MPa | | | |

| Result of | Screw back | 4 | | MPa | B | A | B |
|---|---|---|---|---|---|---|---|
| observation of | pressure at time of | 10 | | MPa | | B | |
| black streak | melt kneading of | 20 | | MPa | | | |
| | injection molding | 30 | | MPa | | | |
| | | 40 | | MPa | | | |
| | | 50 | | MPa | | | |
| Fluidity | MFR | 280° | C. | g/10 min | 14.5 | 14.5 | 18.5 |
| | MVR | 300° | C. | cm³/10 min | 13.9 | 13.9 | 16.2 |
| Impact | Notched Izod | 23° | C. | kJ/m² | 69.5 | 69.5 | 57.2 |
| characteristic | impact strength | 0° | C. | kJ/m² | 64.0 | 64.0 | 45.6 |
| | | −20° | C. | kJ/m² | 58.3 | 58.3 | 38.5 |
| | | −30° | C. | kJ/m² | 58.2 | 58.2 | 30.5 |
| Tensile | Yield strength | 23° | C. | MPa | 55.6 | 55.6 | 50.5 |
| characteristic | Breaking strength | | | MPa | 61.8 | 61.8 | 48.5 |
| | Tensile modulus | | | MPa | 2,021 | 2,021 | 2,000 |
| | Elongation at break | | | % | 101.0 | 101.0 | 68.0 |
| Bending | Bending strength | 23° | C. | MPa | 79.8 | 79.8 | 58.0 |
| characteristic | Bending modulus | | | MPa | 1,997 | 1,997 | 7,920 |
| Thermal | HDT | 1.8 | MPa | ° C. | 124.8 | 124.8 | 119.5 |
| characteristic | | | | | | | |

As can be seen from the table, the polycarbonate-based resin composition of the present invention is suppressed in occurrence of a black streak at the time of its molding while maintaining excellent characteristics (such as impact resistance, in particular, impact resistance at low temperature) of the polyorganosiloxane-polycarbonate copolymer.

Meanwhile, as can be seen from Comparative Examples 1 to 3 in the table, a black streak-like pattern is liable to occur in a polycarbonate-based resin composition free of the hydrolysis resistant agent (C).

### INDUSTRIAL APPLICABILITY

The polycarbonate-based resin composition of the present invention can provide a white molded article having satisfactory low-temperature impact resistance because the resin composition is suppressed in occurrence of a black streak or the like at the time of its molding despite containing the PC-POS copolymer and the white pigment, and can maintain excellent low-temperature impact resistance derived from the PC-POS copolymer. The molded article can be suitably used in parts for electrical and electronic equipment or casings for the equipment, parts for the interior and exterior of lighting equipment, parts for the interior and exterior of a vehicle, food trays, and eating utensils. In particular, the molded article is suitable as a material for a casing for a cellular phone, a mobile personal computer, a digital camera, a video camera, an electric tool, or the like.

1. A polycarbonate-based resin composition, comprising a polycarbonate-based resin (A) containing a polycarbonate-polyorganosiloxane copolymer (A1) containing a polycarbonate block formed of a repeating unit represented by the following general formula (I) and a polyorganosiloxane block containing a repeating unit represented by the following general formula (II), and 0.5 part by mass or more to 40 parts by mass or less of a white pigment (B) and 0.02 part by mass or more to 5.0 parts by mass or less of a hydrolysis resistant agent (C) with respect to 100 parts by mass of the polycarbonate-based resin (A): 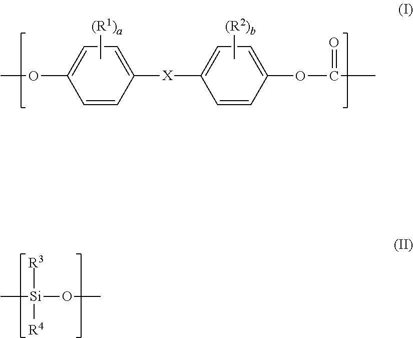
wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and a and b each independently represent an integer of from 0 to 4.

2. The resin composition according to claim 1, wherein the polyorganosiloxane block has an average chain length of 50 or more.

3. The resin composition according to claim 1, wherein a content of the polycarbonate-polyorganosiloxane copolymer (A1) in the polycarbonate-based resin (A) is 10 mass % or more to 100 mass % or less.

4. The resin composition according to claim 1, wherein a content of the polyorganosiloxane block in the polycarbonate-polyorganosiloxane copolymer (A1) is 1.0 mass % or more to 70 mass % or less.

5. The resin composition according to claim 1, wherein a moisture concentration value of the white pigment (B) obtained by subtracting a moisture concentration thereof measured at from 0° C. to 120° C. by a Karl-Fischer method from a moisture concentration thereof measured at from 0° C. to 300° C. by the Karl-Fischer method is 8,000 ppm by mass or less.

6. The resin composition according to claim 1, wherein the white pigment (B) comprises one or more selected from the group consisting of titanium oxide, zinc sulfide, zinc oxide, and barium sulfate.

7. The resin composition according to claim 6, wherein the white pigment (B) comprises titanium oxide.

8. The resin composition according to claim 7, wherein a crystal structure of the titanium oxide comprises a rutile-type structure.

9. The resin composition according to claim 7, wherein the titanium oxide has, on titanium oxide having an average particle diameter of from 0.10 μm to 0.45 μm, a metal oxide layer formed of an oxide of one or more metals selected from the group consisting of silicon, aluminum, titanium, zinc, and zirconium, and an organic layer containing one or more compounds selected from the group consisting of a polyol, a siloxane, a silane coupling agent, and stearic acid in the stated order.

10. The resin composition according to claim 1, wherein the hydrolysis resistant agent (C) comprises one or more selected from the group consisting of an amide compound (C1), an imide compound (C2), and an epoxy compound (C3).

11. The resin composition according to claim 10, wherein the amide compound (C1) comprises one or more amide compounds selected from the group consisting of compounds represented by the following general formula (c1-a), the following general formula (c1-b), and the following general formula (c1-c): 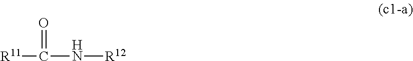
wherein R¹¹ represents a chain aliphatic group having 6 to 24 carbon atoms, and R¹² represents a hydrogen atom or a chain aliphatic group having 6 to 24 carbon atoms; 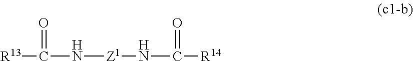
wherein R¹³ and R¹⁴ each independently represent a chain aliphatic group having 6 to 24 carbon atoms, and Z¹ represents a divalent group having 1 to 12 carbon atoms; 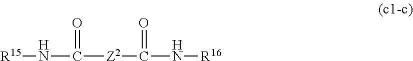
wherein R¹⁵ and R¹⁶ each independently represent a chain aliphatic group having 6 to 24 carbon atoms, and Z² represents a divalent group having 1 to 12 carbon atoms.

12. The resin composition according to claim 10, wherein the imide compound (C2) comprises a carbodiimide compound.

13. The resin composition according to claim 10, wherein the epoxy compound (C3) comprises a cyclic epoxy compound.

14. The resin composition according to claim 10, wherein the epoxy compound (C3) comprises one or more epoxidized oils selected from the group consisting of an epoxidized natural oil and an epoxidized synthetic oil.

15. The resin composition according to claim 10, wherein a blending amount of the amide compound (C1) with respect to 100 parts by mass of the polycarbonate-based resin (A) is 0.1 part by mass or more to 5.0 parts by mass or less.

16. The resin composition according to claim 10, wherein a blending amount of the imide compound (C2) with respect to 100 parts by mass of the polycarbonate-based resin (A) is 0.1 part by mass or more to 5.0 parts by mass or less.

17. The resin composition according to claim 10, wherein a blending amount of the epoxy compound (C3) with respect to 100 parts by mass of the polycarbonate-based resin (A) is 0.02 part by mass or more to 0.5 part by mass or less.

18. The resin composition according to claim 1, further comprising an antioxidant (D).

19. A molded article, comprising the resin composition of claim 1.
